(19) United States
(12) Patent Application Publication
(10) Pub. No.: US 2023/0127876 A1
(43) Pub. Date: Apr. 27, 2023

(54) METHOD AND APPARATUS FOR COMMUNICATING IN A BASE STATION USING A PLURALITY OF TRANSMISSION AND RECEPTION POINTS

(71) Applicant: Electronics and Telecommunications Research Institute, Daejeon (KR)

(72) Inventor: Sung Cheol CHANG, Daejeon (KR)

(21) Appl. No.: 17/968,007

(22) Filed: Oct. 18, 2022

(30) Foreign Application Priority Data
Oct. 18, 2021 (KR) 10-2021-0138560

(51) Int. Cl. H04W 72/121; H04W 76/30; H04W 36/00

(52) U.S. Cl. CPC H04W 72/121; H04W 36/0061; H04W 76/30

(57) ABSTRACT

An operation method of a transmission and reception point (TRP) constituting a base station may include: receiving, from a first distributed unit (DU) and through a first physical layer, scheduling information of a first terminal and first data to be transmitted to the first terminal; receiving, from a second DU and through the first physical layer, scheduling information of a second terminal to be provided to the second terminal and second data to be transmitted to the second terminal; and simultaneously transmitting the first data and the second data to the first terminal and the second terminal, respectively, through a second physical layer based on the scheduling information of the first terminal and the scheduling information of the second terminal.

### CROSS-REFERENCE TO RELATED APPLICATION(S

This application claims priority to Korean Patent Application No. 10-2021-0138560, filed on Oct. 18, 2021 with the Korean Intellectual Property Office (KIPO), the entire content of which is hereby incorporated by reference.

### BACKGROUND

### 1. Technical Field

Exemplary embodiments of the present disclosure relate to a communication technique using transmission and reception points (TRPs), and more specifically, to a technique for providing a communication service using a plurality of TRPs.

### 2. Description of Related Art

In a mobile communication system, a base station connected to a network provides a radio connection to a terminal moving within a radio communication coverage of the base station. The terminal may be bidirectionally connected to the network by using a process of bidirectionally exchanging data with the connected base station. The moving terminal can maintain connection with the network by changing the connected base station according to a handover scheme. The base station that provides a radio connection to the terminal performs a role of actively managing resources in the radio communication coverage of the base station. The terminal managed by the base station exchanges data with the base station through a process of transmitting and receiving radio signals in an allowed resource.

The base station may be configured variously according to the size of the radio communication coverage of the base station in which a radio communication connection is provided. When designing the network, a network designer may deploy the network so that the radio communication coverages of base stations providing radio communication coverages of various sizes overlap between them. By overlapping the radio communication coverages of the base stations, the terminal may be provided with continuous radio access.

In general, the size (area) of the radio communication coverage provided by the base station depends on a frequency, and the size (area) of the radio communication coverage decreases as the frequency increases. Recently, as a method for expanding the size of the radio communication coverage of the base station, a method of configuring a plurality of transmission/reception points for transmitting and receiving radio signals to and from a terminal as a part of the base station has been proposed. The transmission/reception point is a device that transmits and receives radio signals with the terminal, and may constitute one base station as deployed in the same location as the base station or in a remote location. One base station may be configured in a manner in which radio access functions are centralized or in a manner in which the functions are split. The base station in which radio access functions are split may be composed of a central unit (CU) providing higher functions and distributed unit(s) (DU(s)) providing lower functions.

There is a demand for a method capable of reliably providing specific service data at a high speed using base stations having such the distributed structure.

### SUMMARY

Exemplary embodiments of the present disclosure provide a method and an apparatus for reliably providing service data at a high speed.

Exemplary embodiments of the present disclosure also provide a method and apparatus for reliably providing service data at a high speed by using base station apparatuses having a distributed radio access structure.

According to a first exemplary embodiment of the present disclosure, an operation method of a transmission and reception point (TRP) constituting a base station may comprise: receiving, from a first distributed unit (DU) and through a first physical layer, scheduling information of a first terminal and first data to be transmitted to the first terminal; receiving, from a second DU and through the first physical layer, scheduling information of a second terminal to be provided to the second terminal and second data to be transmitted to the second terminal; and simultaneously transmitting the first data and the second data to the first terminal and the second terminal, respectively, through a second physical layer based on the scheduling information of the first terminal and the scheduling information of the second terminal.

The first physical layer may include a first physical lower-split (PHY-Low-S) sublayer subordinately connected to the first DU and a second physical lower-split (PHY-Low-S) sublayer subordinately connected to the second DU.

The second physical layer may include a physical lower-common (PHY-Low-Comm) sublayer for communicating with the first terminal and the second terminal.

The operation method may further comprise transmitting uplink data to the first DU through the first PHY-Low-S sublayer when uplink data is received from the first terminal through the PHY-Low-Comm sublayer.

The operation method may further comprise switching a connection for the first terminal from the first PHY-Low-S sublayer to the second PHY-Low-S sublayer when a DU switching message requesting switching to the second DU for the first terminal is received from the first DU.

The DU switching message may include at least one of information on a serving DU, information on a target DU, information on a DU switching time, resource information, DU switching indication information, or combinations thereof.

The operation method may further comprise transmitting uplink data to the second DU through the second PHY-Low-S sublayer when the uplink data is received from the first terminal through the PHY-Low-Comm sublayer.

The PHY-Low-Comm sublayer may provide a radio interface for transmitting and receiving data with the first terminal and the second terminal.

According to a second exemplary embodiment of the present disclosure, a transmission and reception point (TRP) apparatus constituting a base station may comprise: a first physical layer configured to receive, from a first distributed unit (DU), scheduling information of a first terminal and first data to be transmitted to the first terminal, and receive, from a second DU, scheduling information of a second terminal to be provided to the second terminal and second data to be transmitted to the second terminal; a second physical layer configured to simultaneously transmit the first data and the second data to the first terminal and the second terminal, respectively, through a second physical layer based on the scheduling information of the first terminal and the scheduling information of the second terminal; and a processor configured to control a connection between the first physical layer and the second physical layer.

The first physical layer may include a first physical lower-split (PHY-Low-S) sublayer subordinately connected to the first DU and a second physical lower-split (PHY-Low-S) sublayer subordinately connected to the second DU.

The second physical layer may include a physical lower-common (PHY-Low-Comm) sublayer for communicating with the first terminal and the second terminal.

When uplink data is received from the first terminal through the PHY-Low-Comm sublayer, the processor may further control the uplink data to be transmitted to the first DU through the first PHY-Low-S sublayer.

When a DU switching message requesting switching to the second DU for the first terminal is received from the first DU, the processor may further control a connection for the first terminal to be switched from the first PHY-Low-S sublayer to the second PHY-Low-S sublayer.

The DU switching message may include at least one of information on a serving DU, information on a target DU, information on a DU switching time, resource information, DU switching indication information, or combinations thereof.

When uplink data is received from the first terminal through the PHY-Low-Comm sublayer, the processor may further control the uplink data to be transmitted to the second DU through the second PHY-Low-S sublayer.

The PHY-Low-Comm sublayer may provide a radio interface for transmitting and receiving data with the first terminal and the second terminal.

According to a third exemplary embodiment of the present disclosure, a method by a first distributed unit (DU) may comprise: communicating with a first terminal through a first transmission and reception point (TRP), wherein the first TRP is connected to the first DU and a second DU; identifying whether a DU switching condition for DU switching from the first DU to the second DU is satisfied for the first terminal; cooperating with the second DU for the first terminal when the DU switching condition is satisfied; transmitting a DU switching message including a result of the cooperation to the first TRP; and releasing a connection with the first TRP for the first terminal.

The DU switching message may include at least one of information on a serving DU, information on a target DU, information on a DU switching time, resource information, DU switching indication information, or combinations thereof.

The communicating with the first terminal may comprise: transmitting scheduling information of the first terminal to a first physical lower-split (PHY-Low-S) sublayer subordinate to the first DU through a physical higher (PHY-High) sublayer; and transmitting first data to be transmitted to the first terminal to the first PHY-Low-S sublayer subordinate to the first DU through the PHY-High sublayer.

The cooperating may comprise: providing, to the second DU, at least one of information on a service for the first terminal, a data transmission rate, a resource allocated to the first TRP, a DU switching time, or combinations thereof; and receiving, from the second DU, a response of accepting or modifying a DU switching.

Meanwhile, according to the present disclosure, service data can be provided reliably at a high speed. In particular, according to the present disclosure, service data can be provided reliably at a high speed using base station apparatuses having a distributed radio access structure. For example, performance of the communication system can be improved by simultaneously transmitting high-capacity data reliably at a high speed, such as in an extreme reality (XR) service. In addition, users can seamlessly receive the XR services, thereby increasing satisfaction with service quality as well as communication quality.

### BRIEF DESCRIPTION OF DRAWINGS

FIG. 1 is a conceptual diagram illustrating an exemplary embodiment of a wireless communication network.

FIG. 2 is a block diagram illustrating an exemplary embodiment of a communication node constituting a wireless communication network.

FIG. 3 is a diagram illustrating connection between a base station and a core network in a wireless communication network using a base station having a distributed structure to which the present disclosure is applicable.

FIG. 4 is a configuration diagram illustrating connections in base stations each having a plurality of TRPs according to an exemplary embodiment of the present disclosure.

FIG. 5 is a diagram illustrating a hierarchical configuration of base stations including a dual access TRP according to the present disclosure.

FIG. 6A is a conceptual diagram of a base station network for describing a connection between DU and TRP according to an exemplary embodiment of the present disclosure.

FIG. 6B is an exemplary diagram for describing handover in single access TRPs according to an exemplary embodiment of the present disclosure.

FIG. 6C is an exemplary diagram for describing handover in single access TRPs according to another exemplary embodiment of the present disclosure.

FIG. 6D is an exemplary diagram for describing TRP switching in single access TRPs according to another exemplary embodiment of the present disclosure.

FIG. 6E is an exemplary diagram for describing handover in a dual access TRP according to an exemplary embodiment of the present disclosure.

FIG. 6F is an exemplary diagram for describing dual access handover and coordinated multi-point (CoMP) transmission and reception of multiple TRPs according to an exemplary embodiment of the present disclosure.

FIG. 7A is an exemplary diagram illustrating a connection structure of a direct type between a DU and an RU.

FIG. 7B is an exemplary diagram illustrating a connection structure of a relay type between a DU and an RU.

FIG. 7C is an exemplary diagram illustrating a connection structure of an inter-gNB type between a DU and an RU.

FIG. 8 is an exemplary diagram for describing transmission processing times based on connection schemes between DUs and RUs constituting a base station.

FIG. 9 is an exemplary diagram of configuring a network with dual access TRPs according to an exemplary embodiment of the present disclosure.

FIG. 10 is an exemplary diagram for describing a DU coverage and a TRP coverage according to the present disclosure.

FIG. 11 is an exemplary diagram for describing a DU coverage and a TRP coverage according to the present disclosure.

FIG. 12 is an exemplary diagram of a case of configuring a dual access TRP with a plurality of TRPs according to an exemplary embodiment of the present disclosure.

FIG. 13 is an exemplary diagram for describing a DU switching region in the case of having two different dual access TRPs according to an exemplary embodiment of the present disclosure.

FIG. 14 is an exemplary diagram for describing a DU switching region in the case of having two different dual access TRPs according to another exemplary embodiment of the present disclosure.

FIG. 15 is an exemplary diagram for describing an operation according to resource nulling according to an exemplary embodiment of the present disclosure.

FIG. 16 is an exemplary diagram for describing an operation according to resource nulling according to another exemplary embodiment of the present disclosure.

FIG. 17 is a control flowchart for TRP switching when providing services to a terminal according to an exemplary embodiment of the present disclosure.

FIG. 18 is a control flowchart for DU switching when providing services to a terminal according to an exemplary embodiment of the present disclosure.

FIG. 19 is a control flowchart when a call transfer is requested from a neighboring DU according to an exemplary embodiment of the present disclosure.

FIG. 20 is a control flowchart when a dual access TRP communicates with a terminal according to an exemplary embodiment of the present disclosure.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “neighboring” versus “directly neighboring,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system or memory system to which exemplary embodiments according to the present disclosure are applied will be described. The communication system or memory system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

In a mobile communication system, a base station connected to a network can provide a radio connection to a terminal moving within a coverage. The terminal can be bidirectionally connected to the network through a process of bidirectionally exchanging data with the connected base station. The mobile terminal can maintain connection with the network by changing a connected base station in a handover scheme. The base station may play a role of proactively managing resources within a coverage providing a connection to the terminal. The terminal managed by the base station can exchange data with the base station through a process of transmitting and receiving radio signals using allocated resources.

The base station may be configured variously according to the size of the radio communication coverage of the base station in which a radio communication connection is provided. When designing the network, a network designer may deploy the network so that the radio communication coverages of base stations providing radio communication coverages of various sizes overlap between them. By overlapping the radio communication coverages of the base stations, the terminal may be provided with continuous radio access.

In general, the size (area) of the radio communication coverage provided by the base station depends on a frequency, and the size (area) of the radio communication coverage decreases as the frequency increases. Recently, as a method for expanding the size of the radio communication coverage of the base station, a method of configuring a plurality of transmission/reception points for transmitting and receiving radio signals to and from a terminal as a part of the base station has been proposed. The transmission/reception points may constitute one base station as deployed in the same location or in remote locations. One base station may be configured in a manner in which radio access functions are centralized or in a manner in which the functions are split. The base station in which radio access functions are split may be composed of a central unit (CU) providing higher functions and distributed unit(s) (DU(s)) providing lower functions.

The terminal may transmit and receive radio signals with cell(s) provided by the base station in a radio section, and transmit and receive data using a hierarchical radio access protocol that performs radio access functions. A service packet generated in a service layer may be delivered to a counterpart through the radio access protocol. The base station may distribute the radio access protocol to distributed devices in functional units, and may be configured as a set of the distributed devices. The radio access function provided by the radio access protocol generally uses a single frequency band and may be performed in a bandwidth part (BWP) within the frequency band. A method of using multiple frequency bands may be classified into carrier aggregation (CA) and dual connectivity (DC) according to a configuration scheme of the radio access protocol.

As a method of using a frequency in a terahertz band, a multi-transmission and reception point (Multi-TRP) technique may be used. One TRP may configure a short service radius for radio communication with a terminal. A moving terminal has a phenomenon in which a quality of radio signals is lowered because the signals rapidly decrease at a boundary of the TRP. Therefore, a method for allowing a terminal to receive radio signals with high quality at the TRP boundary is required.

### 1.1. Wireless Communication Network

A wireless communication network to which exemplary embodiments according to the present disclosure are applied will be described. A wireless communication network to which exemplary embodiments according to the present disclosure are applied is not limited to the contents described below, and exemplary embodiments according to the present disclosure may be applied to various wireless communication networks. Here, the wireless communication network may be used as the same meaning as a wireless communication system.

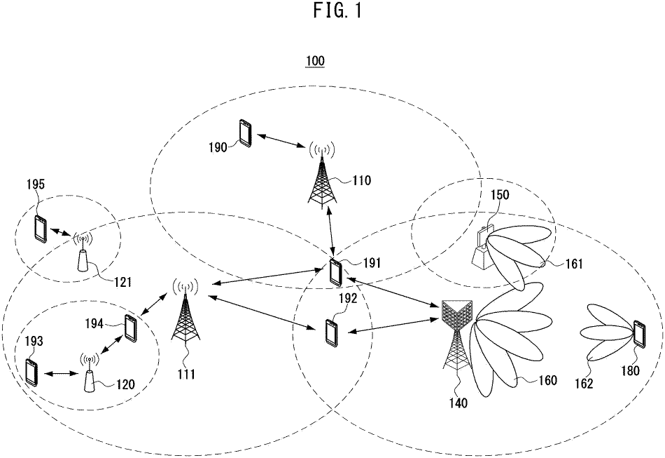

FIG. 1 is a conceptual diagram illustrating an exemplary embodiment of a wireless communication network.

Referring to FIG. 1, a wireless communication network 100 may comprise a plurality of communication nodes 110, 111, 120, 121, 140, 150, 180, 190, 191, 192, 193, 194, and 195. Each of the plurality of communication nodes may support at least one communication protocol. For example, each of the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a space division multiple access (SDMA) based communication protocol, or the like.

The wireless communication network 100 may comprise a plurality of base stations (BSs) 110, 111, 120, 121, 140, and 150, and a plurality of terminals (user equipments (UEs)) 180, 191, 192, 193, 194, 195, and 180. Each of the plurality of base stations 110, 111, and 140 may form a macro cell. Alternatively, each of the plurality of base stations 120, 121, and 150 may form a small cell. The plurality of base station 190 and 191 may belong to a cell coverage of the base station 110. The plurality of base stations 120 and 121 and the plurality of terminals 191, 192, 193, 194, and 195 may belong to a cell coverage of the base station 111. The base station 150 and the plurality of terminals 180, 191, and 192 may belong to a cell coverage of the base station 140.

Each of the plurality of communication nodes 110, 111, 120, 121, 140, 150, 180, 190, 191, 192, 193, 194, and 195 may support a radio access protocol specification of a radio access technology based on cellular communication (e.g., long term evolution (LTE), LTE-Advanced (LTE-A), new radio (NR), etc. which are defined in the 3rd generation partnership project (3GPP) standard). Each of the plurality of base stations 110, 111, 120, 121, 140, and 150 may operate in a different frequency band, or may operate in the same frequency band. The plurality of base stations 110, 111, 120, 121, 140, and 150 may be connected to each other through an ideal backhaul or a non-ideal backhaul, and may exchange information with each other through the ideal backhaul or the non-ideal backhaul. Each of the plurality of base stations 110, 111, 120, 121, 140, and 150 may be connected to a core network (not shown) through a backhaul. Each of the plurality of base stations 110, 111, 120, 121, 140, and 150 may transmit data received from the core network to the corresponding terminals 190, 191, 192, 193, 194, 195, and 180, and transmit data received from the corresponding terminals 190, 191, 192, 193, 194, 195, and 180 to the core network.

Each of the plurality of communication nodes 110, 111, 120, 121, 140, 150, 180, 190, 191, 192, 193, 194, and 195 constituting the wireless communication network 100 may exchange signals with a counterpart communication node without interferences by using a beam formed through a beamforming function using multiple antennas.

Each of the plurality of base stations 110, 111, 120, 121, 140, and 150 may support multiple input multiple output (MIMO) transmissions using multiple antennas (e.g., single user (SU)-MIMO, multi user (MU)-MIMO, massive MIMO, etc.), coordinated multipoint (CoMP) transmission of a plurality of TRPs, carrier aggregation (CA) transmission, unlicensed band transmission, device-to-device (D2D) communication, proximity services (ProSe), dual connectivity transmission, and the like.

Each of the plurality of base stations 110, 111, 120, 121, 140, and 150 may be referred to as a NodeB, evolved NodeB, gNB, ng-eNB, radio base station, access point, access node, node, radio side unit (RSU), or the like. Each of the plurality of terminals 190, 191, 192, 193, 194, 195, and 180 may be referred to as a user equipment (UE), terminal, access terminal, mobile terminal, station, subscriber station, mobile station, portable subscriber station, node, device, Internet of Things (IoT) device, mounted apparatus (e.g., mounted module/device/terminal or on-board device/terminal, etc.), or the like. The present disclosure is not limited to the above-mentioned terms, and they may be replaced with other terms that perform the corresponding functions according to a radio access protocol according to a radio access technology (RAT) and a functional configuration supporting the same.

### 1.2. Communication Node

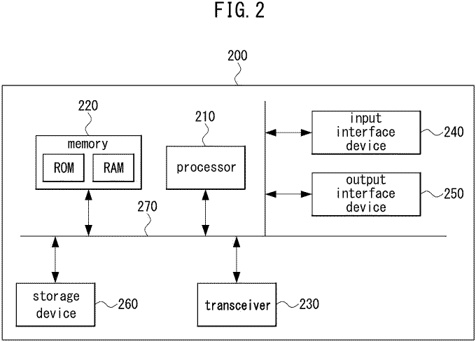

FIG. 2 is a block diagram illustrating an exemplary embodiment of a communication node constituting a wireless communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with exemplary embodiments of the present invention are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Each of the plurality of communication nodes 110, 111, 120, 121, 140, 150, 180, 190, 191, 192, 193, 194, and 195 constituting the wireless communication network 100 and each of the plurality of communication nodes described in the present disclosure may be implemented in the form of the communication node 200.

### 1.3. Base Station Having a Distributed Structure

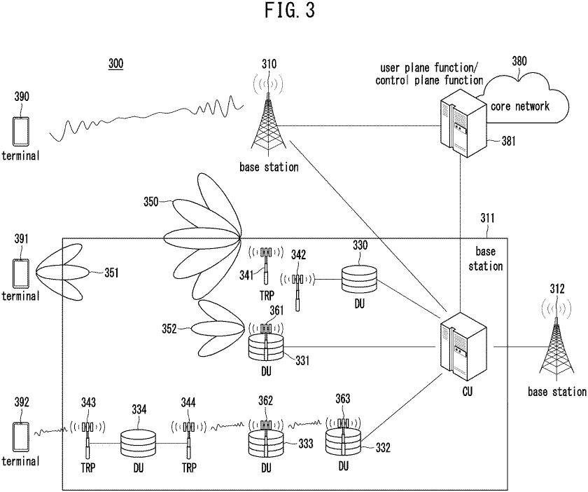

FIG. 3 is a diagram illustrating connection between a base station and a core network in a wireless communication network using a base station having a distributed structure to which the present disclosure is applicable.

Referring to FIG. 3, in a wireless communication network 300 including a core network 380, base stations 310, 311, and 312 may be connected to an end node 381 of the core network 380 through a backhaul.

In addition, the base stations 310, 311, and 312 may transfer data exchanged between the plurality of terminals 390, 391, and 392 and the core network 380 in both directions, that is, from the plurality of terminals 390, 391, and 392 to the core network 380 and from the core network 380 to the plurality of terminals 390, 391, and 392.

The core network 380 illustrated in FIG. 3 may correspond to a 4G core network supporting 4G communication or a 5G core network supporting 5G communication. Here, the core network 380 supporting 4G communication may include a mobility management entity (MME), a serving-gateway (S-GW), a packet data network (PDN)-gateway (P-GW), and the like. The core network 380 supporting 5G communication may include an access and mobility management function (AMF) entity, a user plane function (UPF) entity, a P-GW, and the like.

Here, the end node 381 of the core network 380 may provide a user plane function for exchanging packets composed of service data with the plurality of terminals 390, 391, and 392 and a control plane function for managing access and mobility of the terminals.

The user plane function of the end node 381 may be a serving-gateway (S-GW) in the case of 4G system, a user plane function (UPF) in the case of 5G system, or a network entity that transmits specific service data (i.e., user data) to the plurality of terminals 390, 391, and 392 in the corresponding system in the case of other systems.

The control plane function of the end node 381 may be an MME in the case of 4G system, an AMF function in the case of 5G system, or a network entity for mobility management and/or session management of the plurality of terminals 390, 391, and 392 in the corresponding system in the case of other systems.

In the present disclosure, the terms ‘S-GW’, ‘UPF’, ‘MME’, and ‘AMF’ used in the 4G network and/or 5G network are described as examples for better understanding. However, the present disclosure is not limited to such the 4G network and/or 5G network, and the terms may be replaced with other terms indicating the corresponding functions according to a radio access protocol of a radio access technology (RAT) or entities performing the corresponding functions according to constituent functions of the core network.

The base station 311 composed of a set of distributed devices configured by splitting the functions of the radio access protocol may include a central unit (CU) 320 with a centralized function, a plurality of distributed units (DUs) 330, 331, 332, 333, and 334 with distributed functions, and a plurality of transmission and reception points (TRPs) 340, 341, and 342 for transmitting and receiving signals. In FIG. 3, only the base station 311 is shown as a base station having a distributed structure, but the other base stations 310 and 312 may also be configured identically or similarly to the base station 311 having a distributed structure.

The CU 320, which includes upper functions of the radio access protocol, may be connected to the plurality of DUs 330, 331, 332, 333, and 334 in the direction of a radio section, and may be connected to the end node 381 in the direction of the core network 380. In addition, the CU 320 may be connected to the plurality of neighboring base stations 310 and 312.

Each of the plurality of DUs 330, 331, 332, 333, and 334 which include lower functions of the radio access protocol may be connected to the plurality of TRPs 351, 352, and 353 located at the same geographical location, and each of the plurality of DUs 330 and 334 may be connected to the plurality of TRPs 341, 342, 343, and 344 located at remote locations.

Each of the plurality of base stations 310, 311, and 312 may include a plurality of TRPs for transmitting and receiving radio signals. Each of the TRPs may transmit signals to at least one terminal 390, 391, or 392 and may receive signals from the at least one terminal 390, 391, or 392. Each of the TRPs may provide signals from the at least one of the terminals 390, 391, or 392 to the CU through a DU connected thereto.

Each of the plurality of TRPs 341, 342, 343, 344, 361, 362, and 363 may operate independently or in cooperation with neighboring TRPs. The operation of the plurality of TRPs 341, 342, 343, 344, 361, 362, and 363 will be further described with reference to other drawings.

In addition, each of the plurality of TRPs 341, 342, 343, 344, 361, 362, and 363 may use a beamforming function using multiple antennas. FIG. 3 illustrates a case in which beamforming is performed using multiple antennas at the TRPs 341 and 361. Although FIG. 3 illustrates a case in which beamforming is performed at two TRPs 341 and 361 due to limitation of the drawing, other TRPs may also use the beamforming function. Each of the plurality of TRPs 341, 342, 343, 344, 361, 362, and 363 may exchange signals with a counterpart communication node without interference through a plurality of formed beams. Each of the plurality of TRPs 341, 342, 343, 344, 361, 362, and 363 may refer to a (remote) radio transceiver, remote radio head (RRH), wireless antenna, transmission point (TP), transmission and reception point (TRP), or the like.

Each of the plurality of DUs 330, 331, 332, 333, and 334 may be wired or wirelessly connected to a communication node in the direction of the core network 380. The communication node in the direction of the core network 380 may be another DU or may be the CU 320.

Each of the plurality of DUs 330, 331, and 332 wired to the communication node in the direction of the core network 380 may configure some functions of the radio access protocol of the base station in the radio section to provide radio access to at least one terminal, and may be connected to the CU 320 in a wired section.

Each of the plurality of DUs 333 and 334 wirelessly connected to the communication node in the direction of the core network 380 may configure some functions of the radio access protocol of the base station in the radio section to provide radio access to at least one terminal, and may configure some functions of the radio access protocol of the terminal in the radio section to wirelessly connect to a relay device in the direction of the CU 320, thereby being connected to the CU 320 in both directions. Therefore, the DUs 333 and 334 wirelessly connected to the communication node in the direction of the core network 380 should have both some functions of the base station radio access protocol and some functions of the terminal radio access protocol.

For example, the DU 333 may wirelessly connect to the DU 332 in the direction of the CU 320. Therefore, the DU 332 may be a relay device that relays the connection between the DU 333 and the CU 320. The DU 334 may wirelessly access the DU 333 in the direction of the CU 320. Therefore, the DU 333 may be a relay device that relays the connection between the DU 334 and the CU 320. The plurality of TRPs 343 and 344 connected to the DU 334 may form a beam or may be configured in a region where interference is reduced by a physical method. The TRP 343 may configure some functions of the base station radio access protocol, and the TRP 344 may configure some functions of the terminal radio access protocol.

When a plurality of communication nodes exchange signals using a plurality of beams 160, 161, 162, 350, 351, and 352 formed by the respective communication nodes, each communication node may exchange signals through a beam paired (configured) with a counterpart node. To this end, a plurality of beams of the counterpart communication node are searched, reception strength of each beam is measured, and at least one beam for exchanging signals may be configured based on selection by a communication node participating in communication. In addition, at least one beam for exchanging signals, that is, a beam configured by a specific communication node participating in communication may be changed. A quality of a radio channel can be maintained by changing the beam of the communication node to correspond to a change of a radio channel state or the movement of the communication node.

Hereinafter, a structure and layer-specific functions of a radio access protocol that provides a radio connection between a base station and a terminal in a wireless communication network will be described. In the present disclosure, the structure of the radio access protocol and the functions of each layer are described for the purpose of describing specific exemplary embodiments only, and are not intended to limit the contents of the present disclosure, and include changes or substitutions included in the concept and technical scope of the proposed techniques.

### 1.4. Radio Access Protocol

The radio access protocol may provide functions in which a plurality of communication nodes exchange data and control information by using radio resources in a radio section, and may be hierarchically configured. In the cellular communication (e.g., long term evolution (LTE), LTE-Advanced (LTE-A), new radio (NR), etc. which are the 3rd generation partnership project (3GPP) standards), the radio access protocol may include the following layers.
1) radio layer 1 (RL1) which configures physical signals
2) radio layer 2 (RL2) which controls radio transmissions in radio resources shared by a plurality of communication nodes, transmits data to a counterpart node, and converges data from the counterpart node
3) radio layer 3 (RL3) which performs radio resource managements such as network information sharing, radio connection management, mobility management, and quality of service (QoS) management for multiple communication nodes participating in the mobile network.

The radio layer 1 may be a physical layer and may provide functions for data transfer. The radio layer 2 may include sublayers such as a medium access control (MAC), a radio link control (RLC), a packet data convergence protocol (PDCP), a service data adaptation protocol (SDAP), and the like. The radio layer 3 may be a radio resource control (RRC) layer, and may provide an AS layer control function.

Hereinafter, operation methods of communication nodes in a wireless communication network will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

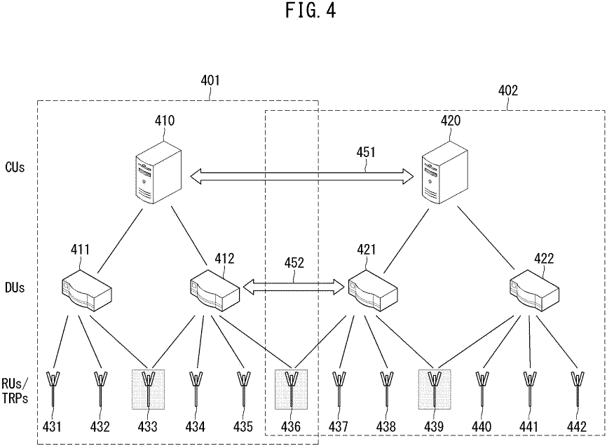

FIG. 4 is a configuration diagram illustrating connections in base stations each having a plurality of TRPs according to an exemplary embodiment of the present disclosure.

Referring to FIG. 4, internal configurations of base stations 401 and 402 are respectively illustrated. A form in which the base station 401 includes a CU 410, DUs 411 and 412, and RUs/TRPs 431, 432, 433, 434, 435 and 436 is illustrated. In addition, a form in which the base station 402 includes a CU 420, DUs 421 and 422, and RUs/TRPs 436, 437, 438, 439, 440, 441 and 442 is illustrated. In the example of FIG. 4, the base stations 401 and 402 will be described assuming that they are gNBs according to a 5G communication system.

The DU 411 included in the base station 401 may be connected to three different TRPs 431, 432, and 433, and the DU 412 included in the base station 401 may be connected to four different TRPs 433, 434, 435, and 436. The DU 421 included in the base station 402 may be connected to four different TRPs 436, 437, 4438, and 439, and the DU 422 included in the base station 402 may be connected to four different TRPs 439, 440, 441, and 442.

The example illustrated in FIG. 4 shows a case assuming that one RU corresponds to one TRP. According to an exemplary embodiment of the present disclosure, one RU may correspond to one TRP. According to another exemplary embodiment of the present disclosure, a plurality of TRPs may correspond to one RU. According to yet another exemplary embodiment of the present disclosure, one TRP may correspond to a plurality of RUs. Here, ‘correspond to’ may mean that the respective components may be connected based on a wired or wireless communication scheme. Therefore, in the present disclosure, a TRP may be understood as an RU, except when the RU and TRP are specifically distinguished and described.

The TRP according to the present disclosure may be classified into a single access TRP and a dual access TRP according to a connection state. Referring to FIG. 4, the single access TRPs 431, 432, 435, 437, 438, 440, 441, and 442 and the dual access TRPs 433, 436, and 439 are illustrated.

### 2. Dual Access TRP

The dual access TRP may be connected to one or a plurality of gNBs, and may transmit signals of a gNB to a terminal and receive signals for a terminal from a gNB. More specifically, the TRP may include a function of generating a radio signal based on data received from a gNB and transmitting it to a terminal, or a function of generating data to be transmitted to a gNB based on a radio signal received from a terminal. That is, the TRP may correspond to a device that performs a function of transmitting and receiving a radio signal, and is a part of a base station (e.g., gNB) as illustrated in FIG. 4. The TRP described above may be understood as an RU.

The TRP 433 included in the base station 401 may be connected to different DUs 411 and 412 within the same base station 401. In addition, the TRP 439 included in the base station 402 may be connected to different DUs 421 and 422 within the same base station 420. However, the TRP 436 may be connected to the DU 412 of the base station 401 and the DU 421 of the base station 402 at the same time. As described above, the dual access TRP may belong to different base stations or to one base station.

Meanwhile, as illustrated in FIG. 4, an interface 451 between the CUs 410 and 420 and an interface 452 between the DUs 412 and 421 included in different base stations are illustrated. The interface between the CUs 410 and 420 may use an X2 interface defined as an inter-base station interface in the 5G system. In addition, the interface between the DUs 412 and 421 may be newly defined and used as a direct interface between the DUs, or the DUs 412 and 421 may be connected through the CUs 410 and 420 connected to the corresponding base stations. Alternatively, the DUs 412 and 421 may be connected through TRP(s) shared by the DUs.

Using the configuration described above and illustrated in FIG. 4, operations of each component according to the present disclosure will be further described.

### 2.1. Architecture

The TRP is a transmission and reception point that transmits and receives radio signals. A gNB, which is a base station of the 5G communication system, may be functionally composed of a CU, DU(s), and remote unit(s) (RU(s)), and the RU may include a TRP. From the perspective of functional split of Cloud-RAN, the RU may be configured according to selection of a functional split scheme. The RU may be split into a higher physical layer and a lower physical layer (i.e., High-PHY <> Low-PHY) based on Option 7 scheme, or may be split into a physical layer and a radio section (i.e., PHY <> RF section) based on Option 8 scheme.

DU operations: Each of the DUs 411, 412, 4211, and 422 may generate data to be transmitted to the terminal using a radio signal for a restricted radio resource, and may transmit the generated data to each of the corresponding RU 431, 432, 433, 434, 435, 436, 437, 438, 439, 440, 441, and/or 442. Each of the DUs 411, 412, 421, and 422 may receive the data corresponding to the restricted radio resource among data received from the corresponding RU.

Dual access RU operations: Each of the dual access RUs 433, 436, and 439 may receive data to be transmitted to a terminal from a plurality of DUs, generate a radio signal for transmitting the data to the corresponding terminal(s), and transmit the data to the terminal through the radio signal. The dual access RUs 433, 436, and 439 may transmit radio signals received from the terminal to a plurality of DUs.

Single access RU operations: Each of the single access RUs 431, 432, 434, 435, 437, 438, 449, 441, and 442 may be connected to one DU existing within the same base station, and may transmit/receive a radio signal with at least one terminal, and exchange (transmit/receive) data with the corresponding DU.

Synchronization condition: Each of the RUs 431 to 442 may compensate for errors in synchronization signals used by a plurality of DUs.

RU/TRP: The RU is a device that includes a TRP, which means a signal transmission point in the specification, and performs some functions of the physical (PHY) layer by being connected to the DU. From the perspective of the radio interface, the RU may be interpreted as an element constituting the network at the rear end of the TRP. As mentioned above, in the present disclosure, a TRP is used to denote an RU, and a case where a TRP is described separately from an RU will be separately described.

### 2.1.1. Dual Access TRP

Dual access TRP: Each of the dual access RU/TRPs 433, 436, and 439 is a device that performs some functions of the PHY layer by being connected to two or more DUs. The dual access RU/TRPs 433, 436, and 439 may perform some functions of the PHY layer, which include receiving and multiplexing data provided by two or more DUs, for data or signal transmission operations to the terminal. The dual access RU/TRPs 433, 436, and 439 may generate a signal for transmission on the radio interface, and transmit the generated signal. For a reception operation from the terminal, the dual access RU/TRPs 433, 436, and 439 may perform some functions of the PHY layer on the radio signal received through the radio interface. The dual access TU/TRPs 433, 436, and 439 may provide the received data to the corresponding DUs.

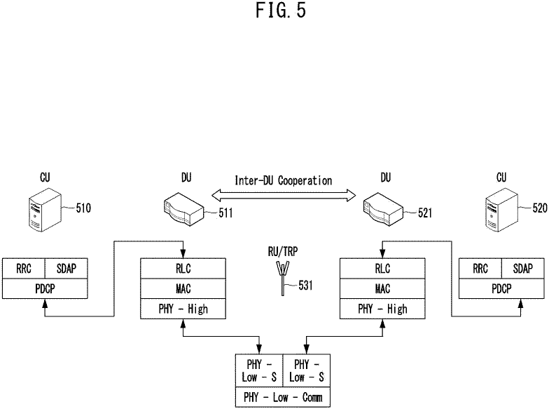

Example of functional split: Each of the dual access TRPs 433, 436, and 439 may be connected to multiple DUs, and implement PHY functions with the DUs according to a functional split scheme. This will be described with reference to FIG. 5.

FIG. 5 is a diagram illustrating a hierarchical configuration of base stations including a dual access TRP according to the present disclosure.

Referring to FIG. 5, CUs 510 and 520 may perform functions of a radio resource control (RRC) layer, service data adaptation protocol (SDAP) layer, and packet data convergence protocol (PDCP) layer. The SDAP layer is a layer defined for quality of service (QoS) flow processing on the 5G radio interface.

The DUs 511 and 521 may perform functions of a radio link control (RLC) layer, medium access control (MAC) layer, and physical higher (PHY-High) sublayer. However, the configuration of the protocol between the CUs 510 and 520 and the DUs 511 and 521 of FIG. 5 corresponds to one example, and may be configured variously according to an implementation scheme.

In addition, a physical layer split between the DU 511 or 521 and the dual access TRP 433, 436, 439, or 531 may be composed of a physical higher (PHY-High) sublayer, physical lower-split (PHY-Low-S) sublayer(s), and physical lower-common (PHY-Low-Comm) sublayer. The PHY-High sublayer refers to a function located in each of the DUs 411, 412, 421, 422, 511, and 521, and corresponds to a higher function of the PHY layer. As described above, the PHY-High sublayer may vary depending on an implementation scheme of the Cloud-RAN system.

Meanwhile, in the present disclosure, since the PHY layer is split into three parts, a form in which it is split into sublayers will be described. However, it should be noted that these sublayers are only for describing one implementation example, and are not intended to limit the present disclosure.

As illustrated in FIG. 5, each of the dual access TRPs 433, 436, 439, and 531 may include PHY-Low-S sublayer(s) and a PHY-Low-Comm sublayer. Since a PHY-Low-S sublayer is located in a TRP 531 and performs functions corresponding to each DU, a PHY-Low-S sublayer corresponding to a connected DU may exist. One PHY-Low-S sublayer of the dual access TRPs 433, 436, 439, and 531 may be provided for each connected DU. That is, each of the plurality of PHY-Low-S sublayers included in each of the dual access TRPs 433, 436, 439, and 531 may be connected to a corresponding one DU.

The PHY-Low-Comm sublayer interworking with each of the PHY-Low-S sublayers corresponding to each DU refers to a physical lower function related to a radio signal transmitted and received through the radio interface of the TRP 531, and has a characteristic connected to a plurality of PHY-Low-S sublayers. The PHY-Low-Comm sublayer may provide a radio interface for transmitting data received from each PHY-Low-S sublayer to a terminal. In addition, the PHY-Low-Comm sublayer may provide data received from a terminal through the radio interface to the PHY-Low-S sublayer.

The DUs 411, 412, 421, 422, 511, and 521 may configure a radio interface protocol with the corresponding CUs 410, 420, 510, and 520 according to a functional split scheme.

Terminal side: A terminal connected to a gNB having the form of the base station illustrated in FIG. 4 and the protocol structure illustrated in FIG. 5 may configure a radio protocol on a radio interface to transmit and receive radio signals for data transmission with the base station gNB. The terminal may configure and use a radio protocol in a manner of transmitting and receiving radio signals in the TRP 531. A DU corresponding to the terminal may be determined and operated. More specifically, a DU corresponding to a certain time is determined, and as a radio protocol corresponding to the DU, a PHY-High sublayer, a PHY-Low-S sublayer, and a PHY-Low-Comm sublayer may be determined.

For example, when a specific terminal communicates with the DU 511 at an arbitrary time, a radio protocol composed of the PHY-Low-Comm sublayer in the TRP 531, PHY-Low-S sublayer connected to the DU 511, and PHY-High sublayer of the DU 511 may be used. Similarly, considering a case where the terminal communicates with the DU 521 at an arbitrary time, a radio protocol composed of the PHY-Low-Comm sublayer in the TRP 531, the PHY-Low-S sublayer connected to the DU 521, and the PHY-High sublayer of the DU 521 may be used.

These protocols operate as protocols corresponding to the radio protocol of the terminal and exchange data with the terminal using radio signals transmitted and received with the terminal. The PHY-High sublayer and the PHY-Low-S sublayer may be changed and operated according to a DU to be subsequently switched. As a DU switching procedure, a switching time detection procedure, a switching procedure, and the like should be performed. When a TRP is not switched while the DU is switched, the PHY-Low-Comm sublayer that finally generates radio signals may be maintained.

Implementation Characteristics: The dual access RU/TRPs 433, 436, 439, and 531 receive data from the corresponding DUs 412, 421, 512, and 521, respectively, and generate radio signals to be transmitted over the radio interface. Since a radio signal received by the terminal is generated in the PHY-Low-Comm sublayer, if the TRP is maintained even if the DU is switched, radio signal characteristics such as band/frequency/synchronization signal may be maintained at the terminal. In particular, in a process of receiving and generating data signals from different DUs for two terminals connected to one dual access TRP, the important band/frequency/synchronization in radio signals may be operated by the PHY-Low-Comm sublayer. This has an advantage that even if the radio signal is generated from data generated in each DU, the DU does not affect errors of the radio signal because the radio signal is generated by one RU (or TRP).

### 2.1.2. Inter-DU Cooperation

Scheduling per DU: As a main function of the DUs 411, 412, 421, 422, 511, and 521, scheduling for allocating radio resources configured in multiple dimensions such as time/frequency/space is important. A function of allocating radio resources to users such as base stations/terminals in operation units (e.g., slot(s), TTI(s), etc.) on the radio interface may be performed in the DUs 411, 412, 421, 422, 511, and 521. A DU performing a function of allocating radio resources operated on the radio interface of the dual access TRP 433, 436, 439, or 531 is required. In general, a scheduler performing the function for allocating radio resources to users is a function performed by the DU 411, 412, 421, 422, 511, or 521. That is, a scheduler (not shown) located in the DU 411, 412, 421, 422, 511, or 521 may allocate radio resources to users. When a scheduler corresponding to radio resources is determined for a specific dual access TRP at a specific time, it means that a corresponding DU is determined. Accordingly, radio resources managed by the scheduler may be fixed from the perspective of each of the DUs 412, 421, 511, and 521 connected to the dual access TRPs 431, 436, 439, and 531. Each of the DUs 412, 421, 511, and 521 connected to the dual access TRPs 431, 436, 439, and 531 may determine a user to allocate a radio resource for each radio resource, share resource allocation information on the radio interface, and perform transmission/reception operations with the base station and the terminal for each radio resource.

Inter-DU cooperation: As described above, in order to determine radio resources managed by each DU, a negotiation procedure between the DUs 412, 421, 511, and 521 connected to the dual access TRPs 431, 436, 439, and 531 may be required. In order to determine radio resources managed by each DU among the DUs 412, 421, 511, and 521 connected to the dual access TRPs 431, 436, 439, and 531, a negotiation procedure for radio resources may be performed between the DUs 412, 421, 511, and 521 connected to the dual access TRPs 431, 436, 439, and 531.

In the present disclosure, a case assuming that each of the DUs 412, 421, 511, and 521 connected to the dual access TRPs 431, 436, 439, and 531 can use radio resources that can be used by the TRP connected to itself through negotiation with other DUs 412, 421, 511, and 521 will be described. However, when the DUs 412, 421, 511, and 521 connected to the dual access TRPs 431, 436, 439, and 531 perform scheduling using only predetermined radio resources, the radio resource negotiation procedure may not be required. The present disclosure does not exclude the case where the DUs 412, 421, 511, and 521 connected to the dual access TRPs 431, 436, 439, and 531 perform scheduling using only predetermined radio resources.

An increase or decrease in radio resources operated by the DU is required proportionally according to an increase or decrease in radio traffic processed by each DU. As a procedure for dividing and operating fixed radio resources between DUs on the radio interface, a negotiation procedure between the DUs may be performed. In a method of variably operating radio resources in a manner in which radio resources increase or decrease according to an increase or decrease in radio traffic for each DU, the radio resource negotiation procedure between the DUs is required. Therefore, in the method of variably operating radio resources in the manner in which radio resources increase or decrease according to an increase or decrease in radio traffic for each DU, the negotiation procedure between the DUs may be performed for each unit time. For this cooperation, a direct interface between the DUs may be configured.

X2 structure: Since an X2 interface is configured as an interface between gNBs, which are base stations of the 5G communication system, information negotiated between the DUs may be exchanged on the X2 interface. In the current technical specification, for the X2 interface, a signaling procedure between gNBs is defined. Therefore, a negotiation procedure related to scheduling for each unit time may be performed between the DUs through a connection provided by the X2 interface. In the case of using the X2 interface between the DUs, negotiation information may be delivered actually through a F1 interface between DU and CU and an X2 interface between CU and CU. Accordingly, in the example of FIG. 5, negotiation information between the DU 511 and the DU 521 is provided to the CU 510 through the F1 interface between the DU 511 and the CU 510, and the CU 510 may deliver the negotiation information to the CU 520 using the X2 interface. The CU 520 may provide the negotiation information received from the DU 511 through the CU 510 to the DU 521 through the F1 interface. Even when the DU 521 provides negotiation information to the DU 511, it may be delivered through the reverse direction of the interfaces described above.

TRP structure: As described in FIGS. 4 and 5, since the TRPs 431, 432, 433, 434, 435, 436, 437, 438, 439, 440, 441, 442, 531 are connected to the DUs 411, 412, 421, 422 , 411, and 521, a connection between DUs may be configured via the corresponding dual access TRP. The DUs 412, 421, 511, and 521 connected to the dual access TRPs 433, 436, 439, and 531 configure a bidirectional communication path with the corresponding TRPs 433, 436, 439, and 531, so that the connection between DUs may be configured in a structure of DU <> TRP <> DU. In this case, a capacity allocated for the connection between DUs is additionally required for the connection between DU and TRP.

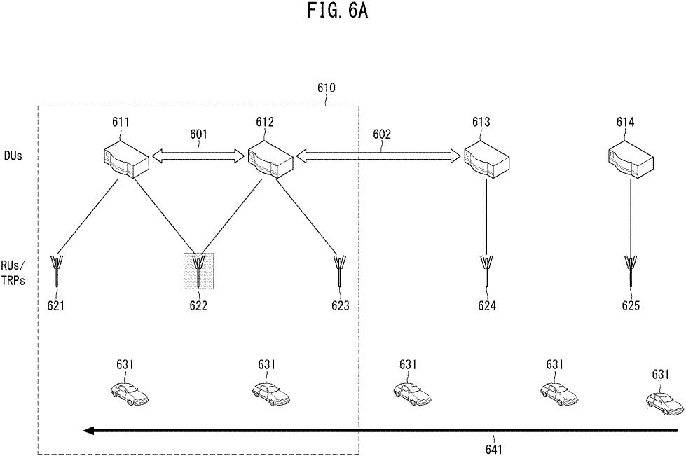

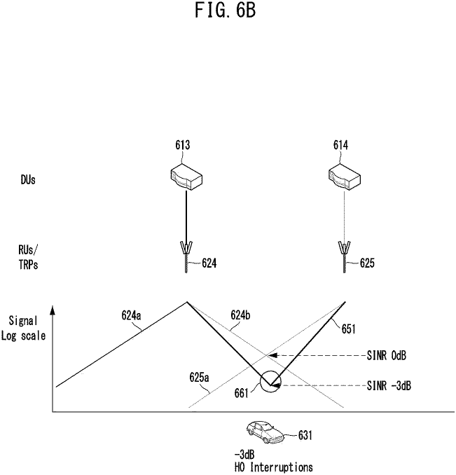

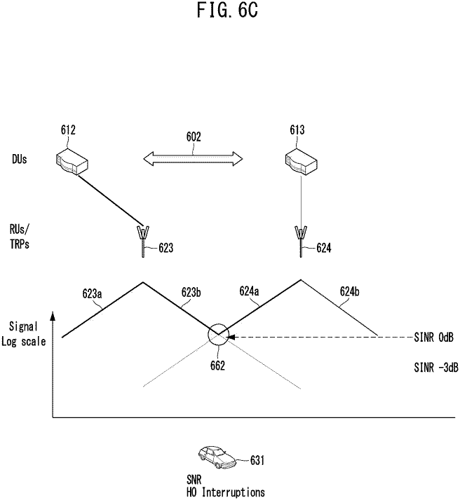

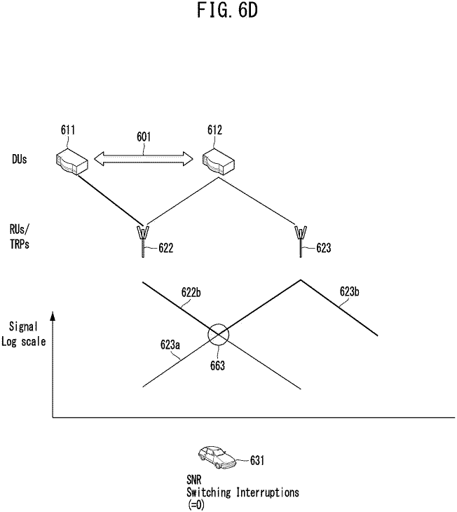

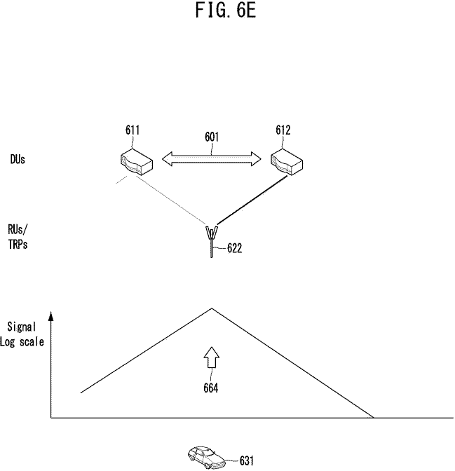

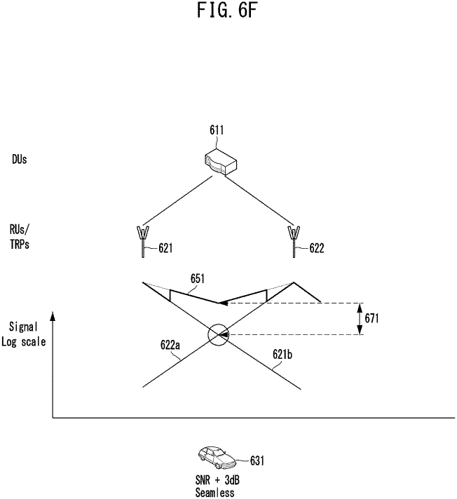

FIG. 6A is a conceptual diagram of a base station network for describing a connection between DU and TRP according to an exemplary embodiment of the present disclosure.

Referring to FIG. 6A, DUs 611, 612, 613, and 614 may be connected to at least one TRP 621, 622, 623, 624, and 625. Specifically, the DU 611 may be connected to the TRPs 621 and 622, the DU 612 may be connected to the TRPs 622 and 623, the DU 613 may be connected to the TRP 624, and the DU 614 may be connected to the TRP 625. Also, in the example of FIG. 6A, the DUs 611 and 612 constitute one gNB 610, and the DUs 613 and 614 may belong to different base stations. More specifically, the TRP 624 and the DU 613 belong to one gNB, and the TRP 625 and the DU 614 may belong to a gNB different from the gNB to which the TRP 624 and the DU 613 belong.

As another example, the DUs 613 and 614 may belong one base station. That is, the TRPs 624 and 625 and the DUs 613 and 614 may belong to one gNB. Also, a reference numeral 610 in FIG. 6A may indicate a base station or a coverage covered by the base station.

Between the DUs 611 and 612 belonging to one gNB 610, the above-described inter-DU cooperation may be performed. The inter-DU cooperation may be performed through a CU (not shown in FIG. 6A) to which the DUs 611 and 612 are connected. As another example, since the DUs 611 and 612 share the TRP 622, they may cooperate using a scheme of DU <> TRP <> DU. As yet another example, when a separate interface is defined between the DUs 611 and 612 belonging to the gNB 610, the cooperation may be performed using the corresponding interface. A connection 601 between the DUs 611 and 612 illustrated in FIG. 6A illustrates cooperation in one of the schemes described above.

In addition, cooperation between the DU 611 belonging to one gNB 610 and the DU 613 belonging to another gNB may be performed in one of the schemes between the DUs 611 and 612 belonging to one gNB 610 described above. A connection 602 between the DU 611 belonging to one gNB 610 and the DU 613 belonging to another gNB illustrates the cooperation between DUs belonging to different base stations.

A terminal 631 is also illustrated in FIG. 6A. When the terminal 631 moves as shown by a reference numeral 641 from a communication coverage of the TRP 625 connected to the DU 614, it may move to a coverage of the TRP 624 connected to the DU 613. In addition, when the terminal 631 moves as shown by the reference numeral 641 from the communication coverage of the TRP 624 connected to the DU 613, it may move to a coverage of the TRP 623 connected to the DU 612.

### 2.2. Terminal Experience

Single access, typical handover: The terminal 631 may receive a signal transmitted by the TRP. When the terminal 631 moves away from the TRP with which it communicates, a strength of the received signal decreases. When the terminal 631 is located at a boundary of a specific TRP (hereinafter referred to as a ‘serving TRP’) providing a service, the terminal 631 may receive a signal of another TRP. An inter-TRP handover for a case where the serving TRP for the terminal 631 and one neighboring TRP operate separately will be described.

Referring to FIG. 6A, when two different TRPs operate separately, the two different TRPs may be the TRPs 625 and 624 or the TRPs 624 and 623. This is because the single access TRP 624 is connected to the DU 613 and the single acess TRP 625 is connected to the DU 614. Similarly, referring to FIG. 6A, the single access TRP 624 is connected to the DU 613 and the single access TRP 623 is connected to the DU 612. However, since the cooperation 602 can be performed between the DUs 612 and 613, additional operations may be performed. Therefore, the case of single access and typical HO will be described with reference to FIG. 6B using the configuration formed between the TRPs 625 and 624.

FIG. 6B is an exemplary diagram for describing handover in single access TRPs according to an exemplary embodiment of the present disclosure.

FIG. 6B is a diagram separately extracted and illustrated to describe the handover between the TRPs 625 and 624 from FIG. 6A described above. Accordingly, configurations identical to those of FIG. 6A will be described using the same reference numerals.

The DU 614 may be connected to one TRP 625, and another DU 613 may be connected to another TRP 624. It is assumed that the terminal 631 initially communicates in the coverage of the TRP 624 connected to the DU 614. Accordingly, the initial serving TRP of the terminal 631 may be the TRP 625. As illustrated by the reference numeral 641 in FIG. 6A, the case where the terminal 631 moves to the target TRP 624 may be considered.

When the terminal 640 communicating at the location of the TRP 625 moves in the direction of the TRP 624 and enters a handover region, a signal strength 625a from the TRP 625 may decrease. In FIG. 6B, the reference numerals 624a and 624b denote a signal strength value on a log scale proportional to a distance between the TRP 624 and the terminal 631, and the reference numeral 625a indicates a signal strength value on a log scale proportional to a distance between the TRP 625 and the terminal 631.

Looking further into the graph illustrated in FIG. 6B, the strength of the signal received at the terminal 631 from the TRP 625 generally increases or decreases in proportion to the square of the distance. Therefore, since the signal strength in FIG. 6B illustrates a signal strength on a log scale, the log scale signal strength 625a corresponding to the distance from the TRP 625 to the direction of the TRP 624 may decrease linearly in proportion to the distance from the TRP 625. Since the signal strength is proportional to the square of the distance, the log scaling on the signal strength may have linear characteristics. In addition, the example of FIG. 6B may be an ideal case assuming that there is no other obstacle or interference between the TRP 625 and the terminal 631.

When interference is considered, a signal received at the terminal 631 from the serving TRP 625 has an SINR value as indicated by a reference numeral 651. That is, since signal(s) received from other neighboring base station(s) act as interference, it has a lower SINR than the reference numeral 625a.

A virtual point where a handover occurs is exemplified by a reference numeral 661. When the terminal 631 moves as shown by the reference numeral 641 illustrated in FIG. 6A, the terminal 631 receiving signals transmitted by the two TRPs 624 and 625 operating separately experiences -3dB SINR at a boundary between the TRPs 624 and 625, and has a characteristic that the received signal rapidly decreases. Therefore, a traditional handover occurs at the virtual handover point as illustrated by the reference numeral 661, and the terminal 631 experiences an interruption time due to the handover. It should be noted that the virtual handover point 661 is referred to as a ‘virtual point’ because it is difficult to specify a point where an actual handover is performed.

In the single access typical HO environment, a signal transmitted from a neighboring TRP affects a terminal located at a boundary as interference. If the serving TRP increases a power of a transmission signal to overcome the interference to the terminal, the signal received at the terminal 631 may increase, but this requires transmission of high power even in the neighboring TRP, so the interference signal received as a result is also increased. Therefore, the quality of the signal received at the terminal does not increase as the TRP density increases.

FIG. 6C is an exemplary diagram for describing handover in single access TRPs according to another exemplary embodiment of the present disclosure.

FIG. 6C is also a diagram separately extracted and illustrated to describe the handover between the TRPs 625 and 624 from FIG. 6A described above. Accordingly, configurations identical to those of FIG. 6A will be described using the same reference numerals.

The DU 612 may be connected to one TRP 623, and another DU 613 may be connected to another TRP 624. It is assumed that the terminal 631 initially communicates in the coverage of the TRP 624 connected to the DU 613. Accordingly, the initial serving TRP of the terminal 631 may be the TRP 624. As exemplified by the reference numeral 641 in FIG. 6A, the case in which the terminal 631 moves to the target TRP 623 may be considered.

Single access, Typical HO, Resource nulling: In FIG. 6C, an operation corresponding to the single access typical handover procedure will be described as described in FIG. 6B. However, as shown by the reference numeral 602, a case in which the DUs 612 and 613 cooperate is considered.

On the X2 interface between gNBs, cooperation for the control plane and the data plane may proceed. In the HO procedure through the X2 interface, the terminal 631 may change the serving gNB. In this handover, a cooperation function not specified in the specification may be performed and a negotiation function for radio resources may be included. A resource nulling function in which a neighboring gNB does not use radio resources used by a serving gNB may eliminate the phenomenon in which signals of a neighboring TRP act as interference experienced by the terminal. This will be described with reference to FIG. 6C.

When the terminal 631 moves from the coverage of the TRP 624 to the direction where the TRP 623 is located as shown by the reference numeral 641 illustrated in FIG. 6A, the TRP 624 has a single access connected to one DU 613. Also, the TRP 623 to which the terminal 631 moves corresponds to a TRP located in another gNB. Therefore, when the terminal 631 moves from the center of the TRP 624 to the direction of the TRP 623 and is located at an arbitrary point 662 of a boundary of the TRP 624, a handover that changes the serving TRP 624 may occur in the terminal 631. That is, a handover from the old serving TPR 624 to the new TRP 623 may occur. In this case, interference during the handover may be reduced through inter-base station cooperation (i.e., inter-gNB cooperation) between the DU 612 of the new TRP 623 and the old TRP 624 according to the present disclosure.

According to the present disclosure, resource nulling may be performed through scheduling between the DU 612 of the TRP 623 and the DU 613 of the TRP 624 to prevent the target TRP 623 from performing signal transmission using the same resource as the resource used for communication by the terminal 631 until the terminal is handed over to the target TRP 623. In addition, according to the present disclosure, for a predetermined time after the handover, resource nulling may be performed to prevent the previous serving TRP 624 from performing signal transmission using the same resource as the resource allocated by the target TRP 623 to which the terminal is handed over. As a result, there occurs an advantage in that the terminal 631 experiences less interference at the boundary and receives a high quality signal. In this case, the handover in which the terminal 631 changes the serving gNB occurs at the boundary by using the X2 interface, and the terminal may experience an interruption time due to the handover. However, the signal received at the terminal 631 from the serving TRP 624 or 623 may be a signal without an interference signal. That is, the received signal of the terminal 631 has an SNR quality without interference. As described above, since the terminal 631 receives an interference signal from a neighboring TRP, interference is considered in the received signal, such as a signal to interference noise ratio (SINR). However, when interference from a neighboring TPR is removed through resource nulling, only a signal to noise ratio (SNR) is considered, so transmission efficiency can be improved from the perspective of reception environment of the terminal.

In addition, the SNR quality has a characteristic that is affected by a radio channel of the serving TRP, and is mainly affected by a distance between the serving TRP and the terminal, obstacles, and the like. As a method of providing a high-quality signal to the terminal 631, the density of TRPs may be increased to shorten the distance between the serving TRP and the terminal.

FIG. 6D is an exemplary diagram for describing TRP switching in single access TRPs according to another exemplary embodiment of the present disclosure.

The example of FIG. 6D is also separately extracted and illustrated to describe TRP switching between the TRPs 623 and 622 from FIG. 6A described above. Accordingly, configurations identical to those of FIG. 6A will be described using the same reference numerals.

The DU 612 may be connected to the TRPs 623 and 622, and another DU 613 may be connected to another TRP 622. It is assumed that the terminal 631 communicates in the coverage of the single access TRP 623 connected to the DU 612. Therefore, the serving TRP of the terminal 631 may be the TRP 623. As illustrated by the reference numeral 641 in FIG. 6A, the case where the terminal 631 moves to the target TRP 622 may be considered.

The terminal 631 may move to the coverage of the TRP 622 while communicating with the TRP 623 that is the serving TRP. In this case, it can be seen that a log scale graph 623a of the signal strength from the TRP 623 decreases in proportion to the distance. Conversely, the log scale graph 622b of the signal strength from the TRP 622 to the terminal 631 also has a form in which the signal strength decreases in proportion to the distance between the terminal 631 and the TRP 622.

In the case of FIG. 6D, even if the terminal 631 performs inter-TRP handover, the DU 612 performing scheduling is not changed, and only the TRPs 622 and 623 connected to one DU 612 are switched. The case where the DU 612 performing scheduling is not changed and the handover of the terminal 631 occurs only between the TRPs in this manner will be referred to as ‘TRP switching’ in the present disclosure.

Accordingly, the DU 612 does not require the inter-DU cooperation during the handover of the terminal 631 described above with reference to FIG. 6C. That is, the DU 612 may perform resource nulling in the respective TRPs 622 and 623 when the handover of the terminal 631 occurs. However, as illustrated in FIG. 6D, the TRP 622 corresponds to a dual access TRP connected also to another DU 611. Therefore, when resource nulling is performed to provide the handover of the terminal 631, cooperation for nulling the resources of the target TRP 622 while the terminal 631 is connected to the serving TRP 623 may be needed through cooperation with the DU 611.

### Dual Access, Resource Nulling

Referring to FIG. 6D described above, dual access and resource nulling will be described.

FIG. 6D shows a structure in which a plurality of TRPs 622 and 623 are connected to one DU 612. Signals transmitted and received by the respective TRPs 622 and 623 are concentrated in the DU 612 and processed by the DU 612. When the terminal 631 moves and changes the TRP for the purpose of seamless service, for example, when moving as shown by the reference numeral 641 illustrated in FIG. 6A, the TRP may be switched within the same DU 612. When the TRPs 622 and 623 connected to one DU 612 are switched in this manner, a TRP switching procedure may be performed in the centralized DU 612 and a procedure with neighboring nodes may be omitted. As described above, the switching between TRPs connected to one DU may be the TRP switching operation. The TRP switching operation in which handover is performed between TRPs connected to one DU may minimize a signal interruption time from the perspective of the terminal 631. This is advantageous in an operation in which subject TRPs are connected to the same DU. In the present disclosure, by emphasizing meaning of the function performed by being connected to the same DU, it may be referred to as ‘inter-TRP switching procedure’. The TRP switching or the inter-TRP switching may apply the resource nulling function that prevents a neighboring TRP from using radio resources used by the serving TRP. The terminal receiving a radio resource used by the serving TRP does not receive an interference signal because the neighboring TRP does not transmit signals in the same resource, so the received signal has an SNR quality. Since the characteristic of the SNR quality has been described above, redundant description will be omitted. As a result, in the handover between TRPs connected to one DU as shown in FIG. 6D, there is an advantage in experiencing reception signal performance of SNR quality and almost zero TRP switching interruption time.

FIG. 6E is an exemplary diagram for describing handover in a dual access TRP according to an exemplary embodiment of the present disclosure.

In the example of FIG. 6E, the same configurations as those of FIG. 6A described above will be described using the same reference numerals. FIG. 6E shows a case where the TRP 622 is maintained but the DUs 611 and 612 are changed.

The TRP 622 may be connected to the DU 612 and connected to the DU 611 at the same time. In this case, a case in which the terminal 631 moves from the coverage of the DU 612 to the coverage of the DU 611 will be assumed and described. When the terminal 631 moves from the coverage of the DU 612 to the coverage of the DU 611, even though it is located within the same TRP 622, a DU performing scheduling should be changed. Accordingly, in the present disclosure, the DU may be switched based on the movement of the terminal 631. This will be referred to as ‘DU switching’ in the present disclosure.

Conditions for performing DU switching may be the same as or different from those of TRP switching.

In the case of TRP switching, it may be basically based on received signal strengths of the terminal and TRPs, distance between the TRP and the terminal, presence or absence of neighboring TRPs, and the like. Specifically, in TRP switching, when a terminal moves from a serving TRP to a neighboring target TRP, the TRP switching conditions may be conditions such as signal strengths and distance between the terminal and the serving TRP when the terminal moves from the serving TRP to a target neighboring TRP.

The case where the conditions of DU switching and TRP switching are the same may be cases in which DU and TRP are individually connected. Specifically, as illustrated in FIG. 6B, the DUs 613 and 614 may be connected to the TRPs 624 and 625, respectively. When each of the DUs 613 and 614 is connected to the TRP 624 or 625, the DU switching may have the same conditions as those of TRP switching.

The case where the conditions of DU switching and TRP switching are different may be the case as illustrated in FIG. 6E. That is, it may correspond to a case where the DUs 611 and 612 are connected to the same TRP 622. When each of the DUs 611 and 612 is connected to one TRP 622, that is, when connected to the dual access TRP according to the present disclosure, the DU switching condition may be different from the TRP switching condition.

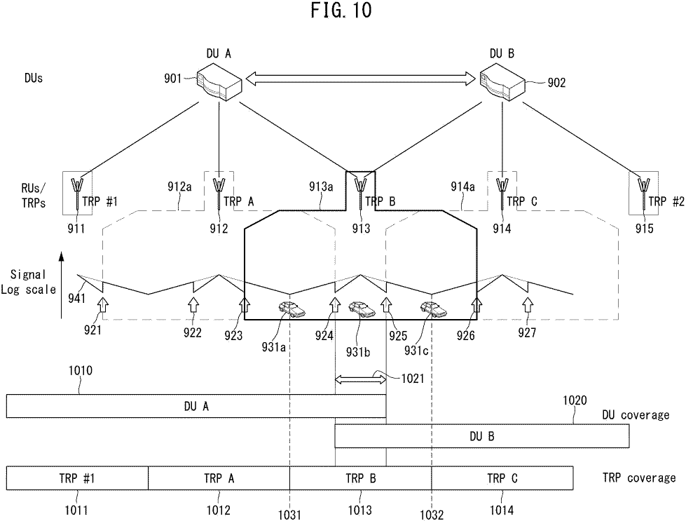

The DU switching condition may be based on the coverage of the DU. Referring to FIG. 6E, the DUs 611 and 612 may know coverages of the DUs in advance. Such a DU coverage will be described below in FIG. 10 to be described later. Therefore, the DU may recognize that the dual access TRP corresponds to an edge of the DU coverage. Even at the edge of the DU coverage, a strength of a signal received from the dual access TRP may not decrease from the perspective of the terminal connected to the dual access TRP. Accordingly, the DU may determine that the DU switching condition is satisfied when the terminal connected to the dual access TRP moves to its edge region.

Based on this, referring to FIG. 6E, the DU 612 may identify that the terminal 631 moves to the edge region of the DU 612. This identification may be performed using at least one of signal strength information reported by the terminal to the DU 612 through the dual access TRP 622, history information on the movement of the terminal 631, sector information in the dual access TRP, beam direction information according to beamforming in the case of the dual access TRP 622 adopting a MIMO scheme, or combinations thereof.

The DU 612 may determine DU switching to the neighboring DU 611 when the terminal moves to the edge of its own coverage. In general, when the DUs 611 and 612 are included within one base station, the DUs 611 and 612 know about neighboring DUs. In addition, even when the DUs are included in different base stations, each DU may have information about a neighboring DU of itself for scheduling and handover. Since FIG. 6E is a diagram extracted from FIG. 6A, the DUs may be DUs included within one base station. However, the DUs included in different base stations may have information on mutually neighboring DUs. In the present disclosure, it is assumed that DUs have information on neighboring DUs regardless of whether base stations are the same.

Accordingly, when the DU 612 determines DU switching, it may perform inter-DU cooperation so that communication between the neighboring DU 611 and the terminal 631 can be maintained through the dual access TRP 622. The inter-DU cooperation, that is, cooperation for the DU switching, may be a procedure of providing information on resources used by the dual access TRP 622, and information on a time when switching should be performed as well as information on a service provided by the DU 612 through the dual access TRP 622. The information on the service may include a type of the service and a required data rate. The required data rate may include a guaranteed minimum data rate. In particular, in the case of the XR service described as an example in the present disclosure, the guaranteed minimum data rate may be one of very important factors.

The DU 612 may provide DU switching cooperation information (or a DU switching cooperation request message) to the DU 611, and receive a response thereto from the DU 611. Upon receiving an affirmative response from the DU 611, that is, a message accepting use of a resource at a time requested by the DU 612, the UD 612 may transmit a DU switching message based on the switching cooperation information to the dual access TRP 622. When the DU switching is performed so that the dual access TRP 622 maintains communication with the terminal 631 connected to the DU 612, the DU switching message may be a message indicating release of the connection with the dual access TRP 622 at the corresponding time and establishment of the connection between the terminal and the target DU 611.

In this case, the dual access TRP 622 may be scheduled by the DU 611 so that the dual access TRP 622 uses the same resource for the same terminal 631. Accordingly, the terminal 631 may perform only switching at an upper level while maintaining radio resources in the dual access TRP 622. In addition, when new information needs to be provided to the terminal due to the DU switching, the corresponding information may be provided to the terminal. As described with reference to FIG. 5, the DU switching may be informed to the terminal 631 using RLC layer information or MAC layer information.

Further, when the DU 611 cannot accept at least one of the contents included in the DU switching cooperation request message of the DU 612, the DU 611 may provide a negative response or a modification request message to the DU 612. The negative response may include information on a reason why the request is not acceptable. Upon receiving the negative response, the DU 612 may update at least one piece of information in the DU switching cooperation request message, and transmit the updated message to the DU 611. In addition, the modification request message provided by the DU 611 may include information of modification on at least one of elements included in the DU switching cooperation request message. For example, when changing the switching time information, the DU 612 may transmit a modification message including the changed time information to the DU 611. Accordingly, the DU 611 may provide a response to the DU 611 when the modification request message is received.

The inter-DU cooperation may proceed using at least some of the schemes described above. Also, in the above, it is assumed that DUs are included within one base station. However, the above operation is possible even when DUs are included in different base stations.

If a base station is changed, the RRC layer may inform the terminal of the change of the base station using an RRC message.

Meanwhile, during DU switching, information between DUs may be provided through the dual access TRP, information between DUs may be provided using an upper CU, or when a separate interface between DUs is defined, the corresponding interface may be used to deliver the information between DUs.

Meanwhile, during the DU switching, the source DU 612 may provide the DU switching message to the dual access TRP 622. This may include information instructing the terminal 631 to maintain communication based on control from another DU, that is, the neighboring DU 611, from a specific time point. Therefore, upon receiving the DU switching message from the source DU, the dual access TRP 622 may release connection with the source DU from the corresponding time point.

The procedure in which the dual access TRP 622 releases the connection with the source DU may be the procedure of releasing the connection of the PHY-Low-S sublayer between the source DU and the terminal and establishing the connection of the PHY-Low-S sublayer of the target DU, as described with reference to FIG. 5. In this case, as described in FIG. 5, the characteristic that the PHY-Low-Comm sublayer of the dual access TRP 622 is not changed may be utilized. Accordingly, the dual access TRP 622 may transmit information scheduled from the target DU 611 through the PHY-Low-Comm sublayer at the time when the DU switching is performed with respect to the terminal 631.

In the above, the case where the source DU 612 transmits the DU switching message to the dual access TRP 622 has been described. However, the target DU 611 may transmit a DU switching message to the dual access TRP 622. In this case, when the DU 611 transmits an affirmative response message corresponding to the DU switching cooperation information (or DU switching cooperation request message) to the DU 612, the DU switching message may be provided to the dual access TRP 622. Accordingly, when the dual access TRP 622 receives the DU switching message from the source DU 612 or the target DU 611, it may perform the same operations as described above.

As illustrated in FIG. 6E, the DU switching may be performed at a specific location 664 having a high signal strength from the TRP 622. Therefore, unlike typical handovers, the DU switching may occur in a state where the strength of the signal received from the TRP 622 is high. Also, during the DU switching, the TRP 622 may share the PHY-Low-Comm sublayer as described above in FIG. 5. Also, the TRP 622 may include PHY-Low-S sublayers corresponding to the respective DUs 611 and 612.

FIG. 6F is an exemplary diagram for describing dual access handover and coordinated multi-point (CoMP) transmission and reception of multiple TRPs according to an exemplary embodiment of the present disclosure.

In the example of FIG. 6F, the same configurations as those of FIG. 6A described above will be described using the same reference numerals. FIG. 6F shows a case in which two different TRPs 621 and 622 are connected to the DU 611. Accordingly, its structure may be similar to that of FIG. 6D. In FIG. 6F, a method for further considering CoMP transmission and reception for two different TRPs 621 and 622 connected to one DU 611 in addition to the above-described method will be described.

The DU 611 may be connected to the TRPs 621 and 622. It is assumed that the terminal 631 communicates in the coverage of the TRP 622 connected to the DU 611. Therefore, the serving TRP of the terminal 631 may be the TRP 622. As exemplified by the reference numeral 641 in FIG. 6A, the case in which the terminal 631 moves to the TPR 622 that is the target TRP may be considered.

The terminal 631 may move to the coverage of the TRP 621 while communicating with the TRP 622 that is the serving TRP. In this case, it can be seen that the log scale graph 622a of the signal strength from the TRP 622 decreases in proportion to the distance. Conversely, the log scale graph 621b of the signal strength from the TRP 621 to the terminal 631 also has a form in which the signal strength decreases in proportion to the distance between the terminal 631 and the TRP 622.

In the case of FIG. 6F, even if the terminal 631 performs inter-TRP handover, the DU 611 performing scheduling is not changed, and only the TRPs 621 and 622 connected to one DU 611 are switched. That is, the TRP switching described above may occur.

In the exemplary embodiment of FIG. 6F, a CoMP transmission/reception technique may be utilized in one DU 611. The CoMP transmission/reception technique may generally include the above-described resource nulling operation when the TRP 622 is the serving TRP. In addition, when a beamforming method using multiple antennas is used together with resource nulling, it may include preventing transmission beams of the TRP 621 from being directed to the terminal 631 receiving a service from the current TRP 622. In addition, in another form of the CoMP scheme, the same data may be transmitted using the same resource during a period of the handover of the terminal 631 from the TRP 622 to the TRP 621. This may be easier because the handover occurs between the TRPs 621 and 622 included within the DU 611.

Then, the operations of FIGS. 6E and 6F, which have been considered above, will be described.

### Dual Access, CoMP

Referring to FIG. 6F, the plurality of TRPs 621 and 622 are connected to one DU 611, and a service can be seamlessly provided to the moving terminal 631 by performing TRP switching. The DU 611 may generate a signal corresponding to data to be transmitted to a specific terminal and transmit the signal to the TRPs 621 and 622. In this case, the DU 611 may control the TRPs 621 and 622 to perform data transmission to the terminal 631 using the same resource and data through the TRPs 621 and 622. Accordingly, the terminal 631 may receive signals transmitted by the TRPs 621 and 622. The terminal 631 may combine and process the signals received from the different TRPs 621 and 622 through a signal processing process, so that the quality of the received signal can be improved.

Since the terminal 631 receives the signals from two TRPs 621 and 622 as shown by a reference numeral 651 illustrated in FIG. 6F, the performance of the radio channel increases by 3 dB as shown by a reference numeral 671, and the terminal 631 may experience high radio signal performance of SNR 3 dB. That is, since the DU 611 does not transmit a signal to another terminal through the same radio resource provided to the terminal 631, there is no need to consider interference. In addition, since the same signal is received from two different TRPs 621 and 622 using the same resource, signal reception efficiency can be increased. That is, the terminal 631 can seamlessly receive high quality signals without signal deterioration at the boundary between the two TRPs.

Meanwhile, as illustrated in FIG. 6E, the DU switching procedure for switching DUs within the same TRP 622 has been described. Looking further into the DU switching, since the DU switching procedure is performed at a time when a signal of good quality is exchanged between the terminal 631 and the TRP 622, the signal quality of the radio signal can be maintained high during the DU switching procedure. The DU switching procedure may be used in accordance with wired and wireless procedures for changing nodes in typical HOs. In particular, seamless data exchange is possible because wired and wireless procedures that reduce data transmission/reception interruption can be used.

On the other hand, the terminal 631 described in the present disclosure is characterized in that seamless service is provided by transmitting and receiving high-quality radio signals using signals transmitted and received in the CoMP scheme at the boundary of TRPs. In addition, in a location where the terminal 631 transmits and receives a high quality radio signal near the TRP, performance improvement due to signals received from the neighboring TRP is small. Therefore, the terminal 631 has sufficient reception performance only with the signal received from the serving TRP.

A process of switching the TRP in the terminal according to the present disclosure will be described in more detail. The terminal located close to the serving TRP may transmit/receive signals to and from the serving TRP. When the terminal moves to a boundary of the serving TRP, a new neighboring TRP may be added. Thereafter, the terminal may move to a coverage of a new serving TRP, which was previously the neighboring TRP, at the boundary of TRPs. When moving to the new serving TRP, the previous serving TRP becomes a neighboring TRP, and a procedure for deleting the previous serving TRP may be performed. The above procedure is the TRP switching described above. Since the operation of adding or deleting a TRP is a procedure that is performed while the serving TRP is connected, an interruption time in data transmission does not occur. The TRP switching procedure may proceed with a preparation procedure and an execution procedure. In the TRP switching procedure, a basis for determination may be based on the strength of signals received from each TRP. Also, in order to prevent a ping-pong phenomenon (i.e., continuous movements between different TRPs), a hysteresis range may be configured for a signal level of the basis for determination, or a conditional execution may be additionally considered.

### 2.3. Extreme Reality (XR) and Transmission Processing Time

The XR services require the characteristics of large-capacity transmission and low-latency transmission. Efforts to improve user data rates at cell boundaries or TRP boundaries are ongoing in the 5G communication for a purpose of providing services uniformly. The dual access scheme provided according to the present disclosure may configure a radio environment in which a plurality of TRPs participate to receive high quality radio signals. Therefore, when configuring the wireless communication network environment according to the present disclosure, large-capacity transmission is possible.

The low-latency transmission depends on a transmission processing time, which is a processing time required for a process in which the RU transmits data determined by the DU as a signal. If a short transmission processing time is implemented in downlink, a time required to transmit data to the terminal is shortened, thereby achieving low-latency transmission.

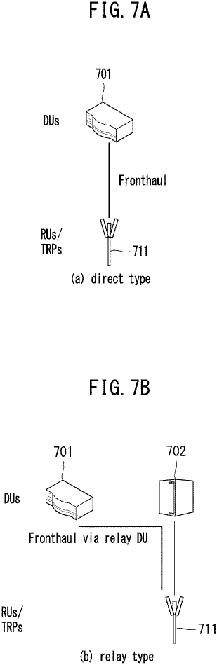

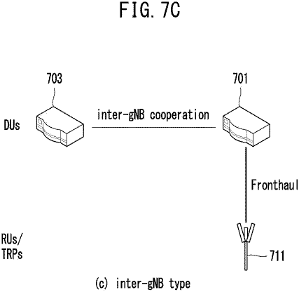

FIGS. 7A to 7C are exemplary diagrams for describing connection schemes between DUs and RUs constituting a base station.

Prior to referring to FIGS. 7A to 7C, the present disclosure has described the method of using Cloud-RAN, and it has been described that in Cloud-RAN, one base station can be configured with a CU, one or more DUs, and one or more RUs/TRPs. Also, in the present disclosure, the interface methods between DUs included in different base stations (gNBs) has been described. In FIGS. 7A to 7C, based on these methods, methods in which DUs and RU/TRPs are connected will be described.

The connection scheme between DUs and RUs may be classified to a direct type, a relay type, and an inter-gNB type.

FIG. 7A illustrates a connection structure of a direct type between a DU and an RU. Referring to FIG. 7A, a DU 701 and a TRP 711 are directly connected, and this type is referred to a direct type connection in the present disclosure. Accordingly, the direct type consists of one hop because the DU 701 and the RU 711 are directly connected, and the DU 701 and the RU 711 may be connected through a fronthaul.

FIG. 7B illustrates a connection structure of a relay type between a DU and an RU. The same configurations as those in FIG. 7A will be denoted by the same reference numerals in FIG. 7B. Referring to FIG. 7B, it is different from FIG. 7A in that another DU 702 is included between the DU 701 and the TRP 711. That is, the DU 701 may be connected to the RU 711 through another DU 702, and since the DU 701 is connected to the RU 711 through the DU 702, this may correspond to a two-hop case. In the example of FIG. 7B, only one DU 702 exists between the DU 701 and the RU 711, but a plurality of DUs may be included between the DU 701 and the RU 711. Also, all of the DUs illustrated in FIG. 7B may be DUs included in one same base station. Therefore, the relay-type connection may be a form in which a fronthaul is configured in multi-hop through neighboring DUs within one base station.

FIG. 7C illustrates a connection structure of an inter-gNB type between a DU and an RU. In FIG. 7C, the same reference numerals are used for the same configurations as those in FIGS. 7A and 7B.

Referring to FIG. 7C, the cooperation scheme between gNBs is a configuration in which the gNBs cooperate as being interconnected. In the configuration illustrated in FIG. 7C, the DU 703 and the DU 701 may be included in different base stations. When the DU 701 and RU 711, which are the components illustrated in FIG. 7A, are included in a first base station, the DU 703 may be a component constituting a second base station that is different from the first base station, for example, a base station neighboring to the first base station. The connection of the DU 703 included in the second base station to the RU 711 included in the first base station may be connected through inter-gNB cooperation between the DU 703 and the DU 701. Since the inter-gNB cooperation does not have a protocol for direct communication between the DU 703 and the DU 701, transmission may be performed through the CU (not shown in FIG. 7C) included in each base station. However, if an interface for direct communication between DUs is provided in the future, the corresponding interface may be used. The present disclosure does not place limitations on interfaces that may be developed in the future.

Also, as illustrated in FIG. 7C , the DU 701 and the RU 711 may be connected through a fronthaul. Based on this connection, data requested to be transmitted by the DU 703 included in the second base station, which is a neighboring gNB, may be received by the DU 701 of the second base station directly from the first base station or through the CU of the second base station. The DU 701 included in the second base station may transmit radio signals in downlink through the RU 711 connected through the fronthaul.

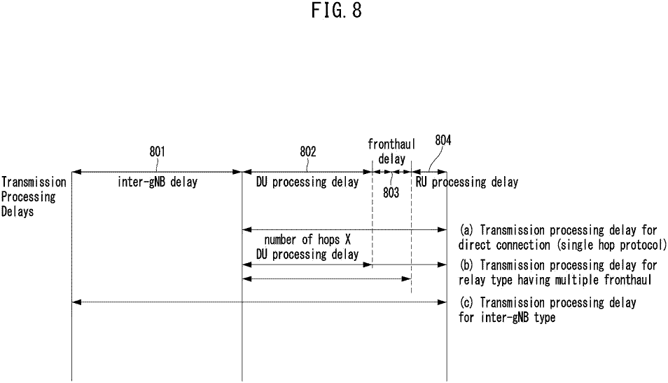

FIG. 8 is an exemplary diagram for describing transmission processing times based on connection schemes between DUs and RUs constituting a base station.

Referring to FIG. 8, a time according to an inter-gNB cooperation delay 801, a time according to a DU processing delay 802 within one DU, a time according to a fronthaul delay 803, and a time according to a RU processing delay 804 are illustrated. In general, the fronthaul delay 803 may be a very short time because the fronthaul is configured using an optical transmission scheme.

As shown in FIG. 7A, the transmission processing time in the direct connection between the DU 701 and the RU 711 may be determined in downlink as a sum of the DU processing delay 802 time, the time of according to the fronthaul delay 803 connecting the DU 701 and the RU 711, and the time of the RU processing delay 804.

As shown in the configuration of FIG. 7B, when at least one DU 702 is included between the DU 701 and the RU 711, the transmission processing time may vary according to the number of hops. Basically, as illustrated in FIG. 8, if at least one DU exists between the DU 701 and the RU 711, the number of hops between the DU and the RU increases. For example, when the DU 701 and the RU 711 are directly connected as shown in FIG. 7A, it corresponds to a case of one hop, and when one DU 702 exists between the DU 701 and RU 711 as shown in FIG. 7B, it corresponds to a case of 2 hops. Therefore, if the number of relaying DUs increases by one, the number of hops also increases by one. Accordingly, the DU processing delay 802 also increases. That is, it can be seen that the DU processing delay 802 increases in proportion to the number of hops.

In the cases of multi-hop in which downlink data is transmitted to the RU via a plurality of DUs, including the case of FIG. 7B, the DU processing delay 802 may increase by the number of hops.

Actually, as the number of hops increases, the fronthaul delay 803 may also increase. However, since the fronthaul itself is configured using the optical transmission scheme as described above, the increase in the fronthaul delay may be negligible. If the fronthaul delay is also accurately considered, the fronthaul delay may be considered based on the number of hops.

Next, when inter-gNB cooperation is performed, as illustrated in FIG. 7C, the DUs 701 and 703 included in different base stations may transmit data between the DUs 701 and 703 based on the inter-gNB cooperation. The time according to the inter-gNB cooperation delay 801 may vary depending on an interface scheme between DUs. That is, as described above, the delay time may vary depending on the case in which a direct interface exists between DUs and the case in which a CU should be passed through. The delay time in the case illustrated in FIG. 7C may be calculated as a sum of the inter-gNB cooperation delay 801, DU processing delay 808, fronthaul delay 803, and RU processing delay 804.

Therefore, among the delay times of FIGS. 7A to 7C, the direct type connection of FIG. 7A has the shortest time. In the relay-type connection of FIG. 7B, a delay time may be added according to the number of hops. In the case of FIG. 7C having the inter-gNB cooperation delay may have the longest transmission processing time.

The transmission processing times or transmission processing delay times based on FIGS. 7A to 7C may be changed according to the connection between the DU and the RU, that is, the configuration of the DU and the RU. However, since the dual access scheme proposed in the present disclosure uses a direct connection configuration, transmission processing time can be minimized. This shortening of the transmission processing time will be evaluated as a method suitable for low-latency transmission for services such as the XR services described above.

### 2.4. RU/TRP Coverage

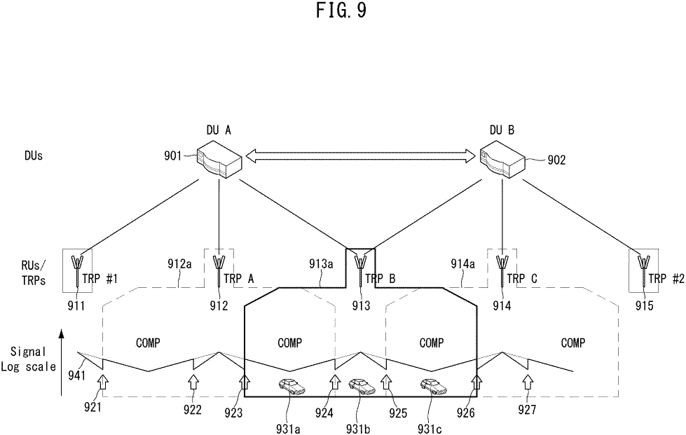

FIG. 9 is an exemplary diagram of configuring a network with dual access TRPs according to an exemplary embodiment of the present disclosure.

Referring to FIG. 9, a DU A 901 and a DU B 902 are shown, and the DU A and the DU B may be included in one base station or may be included in different base stations. Three TRPs 911, 912, and 913 may be connected under the DU A 901. Also, three TRPs 913, 914, and 915 may be connected under the DU B 902.

Each of the TRPs 911, 912, 913, 914, and 915 may have a TRP coverage based on a distance that a radio signal can reach. In FIG. 9, a coverage of the TRP #1 911 and a coverage of the TRP #2 912 are not illustrated, and only a coverage 912a of the TRP A 912, a coverage 913a of the TRP B 913, and a coverage 914a of the TRP C 914 are illustrated.

In FIG. 9, the coverage 912a of the TRP A 912 has a region overlapping with the neighboring TRP B 913, and the coverage 913b of the TRP B 913 has a region overlapping with the neighboring TRP A 912 and a region overlapping with the neighboring TRP C 914. In addition, in correspondence with the location of the terminal 931, reference numerals are identified as 931a, 931b, and 931c.

In FIG. 9, log scale values of signals are illustrated together as described in FIGS. 6A and 6F previously described. Also, it should be noted that a form in which a signal gain occurs using the CoMP scheme according to the present disclosure in an overlapping coverage between the TRPs is also illustrated.

The reference numerals 921, 922, 923, 924, 925, 926, and 927 in FIG. 9 indicate reference points at locations where the signal strength changes based on the CoMP scheme according to the present disclosure. That is, the reference points may correspond to virtual positions at a time when the CoMP scheme according to the present disclosure is applied when the signal strength at the terminal decreases as the distance from the specific serving TRP increases.

As illustrated in FIG. 9, the TRP coverages 912a, 913a, and 914a are configured up to the locations where the radio signals transmitted from the TRPs arrive, and when the terminal is located between the two TRPs, if the same radio resource is used by each TRP to transmit the same data, an effect of combining signals may be obtained. When different TRPs transmit the same data through the same radio resource in this manner, the quality of the signal at the terminal is improved, and when different TRPs transmit different data through the same radio resource, they act as a mutual interference signal, and thus the quality of the signal at the terminal may degrade.

A situation in which the terminal 931a receives a signal will be described with reference to FIG. 9.

The terminal 931a may simultaneously receive signals transmitted by the TRP A 912 and the TRP B 913. In addition, the terminal 931b may theoretically receive only the signal transmitted by the TRP B 913. The terminal 931c may receive signals transmitted by the TRP B 913 and the TRP C 914.

It can be seen from the log scale signals that the quality of the radio signals received by the terminal 931a and the terminal 931c receiving the radio signals transmitted by the two TRPs is improved. This is a result of operating TRPs so that the quality of radio signals is improved compared to the case of receiving radio signals from a single TRP. Since the radio channel state with the TRP B is good, the terminal 931b may satisfy the required quality even if it receives only the radio signal transmitted from one TRP 913.

### 2.5. RU/TRP Switching

In the description of the previous drawings, RU/TRP switching has been described. The TRP switching is a process of changing a TRP, a device that transmits and receives radio signals. The TRP switching has a characteristic in that a location at which radio signals are transmitted and received, that is, a TRP is changed. The procedure for changing a TRP may include a procedure for adding a TRP, releasing a TRP, or changing a TRP.

The addition of a TRP may be a procedure of adding a new TRP to be switched, that is, a target TRP, in addition to a serving TRP providing the existing service. The target TRP may provide a service by adding a new radio channel for communication with the corresponding terminal or allocating the same radio channel as the serving TRP to the corresponding terminal. That is, when the target TRP is added, radio resources may be allocated to the terminal and communication may be performed using the allocated resources.

The release of a TRP may be a procedure for releasing a connection between the existing serving TRP and the terminal when the target TRP is connected, immediately, after a predetermined time, or if a preset condition is satisfied. The TRP may be released based on a predetermined condition.

Describing a predetermined condition as an example, it may be determined that a TRP release condition is satisfied when a reliable connection is established between the added TRP and the terminal (when the communication channel from the added TRP is equal to or greater than a specific reference value).

As another example, the terminal may determine that a release condition of the serving TRP is satisfied when a signal received from the existing serving TRP is less than or equal to a threshold value.

As yet another example, when a predetermined time elapses after the target TRP is added, it may be determined that a release condition of the serving TRP is satisfied.

As yet another example, when the location of the terminal can be detected, it may be determined that a release condition is satisfied when the terminal moves to a coverage of the target TRP by a preset distance and/or moves away from a coverage of the serving TRP by a preset distance.

As yet another example, it may be determined that a TRP release condition is satisfied based on a combination of two or more of the conditions described above.

From the perspective of the terminal, the addition of a TRP results in an increase in the number of connected TRPs that transmit and receive radio signals. Therefore, it is possible to configure an environment in which a plurality of TRPs are connected to one terminal in a specific environment. The terminal may be connected to at least one TRP, and may be connected to two or more TRPs at a TRP boundary. Alternatively, interference may be minimized by preventing data from being transmitted using the same radio resource from one TRP during TRP switching.

The terminal 931a may receive signals simultaneously transmitted by the TRP A 912 and the TRP B 913. When the terminal 931 moves from the location of 931a to the location of 931b, the TRP A 912 may be released. Accordingly, a TRP release signaling procedure for TRP release may be performed between the TRP A 912 and the terminal 913. The TRP C 914 may be added while the terminal 931 moves from the location of 931b to the position of 931c. Accordingly, a TRP addition signaling procedure for adding the TRP C 914 may be performed. The TRP switching procedure may include the above-described TRP addition and release procedures. In addition, the TRP switching procedure may include a TRP changing procedure in which TRP addition and TRP release are simultaneously performed.

When the TRP is switched within the same DU, scheduling for resource management is performed in the same manner, and the TRP, which is a location where radio signals transmitted in an allocated resource are transmitted and received, may be changed. The TRP may be changed as a method for changing a physical and geographical location of transmitting generated data in the determined resource. When the TRP is changed within the same DU, since the DU that manages resources, that is, performs scheduling, is the same, data transmission/reception and resource utilization can be continuously performed. From the perspective of the terminal, the allocated resource may be changed, but seamless transmission and reception of radio signals is possible without experiencing interruption in resource allocation.

Identifier for each TRP: According to the present disclosure, an identifier for each TRP may be assigned/operated. The identifier for each TRP may be used in the process of identifying the added TRP. The identifier for each TRP may include a radio cell identifier, or the like. A reason for assigning an identifier to each TRP is to allow the TRP to be identified by the terminal, TRP, and DU by exchanging messages including the TRP identifier in the TRP addition/change/release procedure. The terminal may receive an identifier of a neighboring TRP from neighboring TRP configuration information among control information received from the serving TRP in a process of measuring radio signals of neighboring TRPs. Accordingly, each of TRPs may transmit control information including a TRP identifier for identifying each TRP to the terminal. The terminal may measure a radio signal to identify a neighboring TRP, and may include and provide an identifier for each TRP in a process of reporting the identified neighboring TRP to the base station. The base station may use an identifier for each TRP in a procedure of adding/changing/releasing a TRP.

Neighboring TRP signal generation: In the CoMP transmission scheme in which a plurality of TRPs generate the same signal, a radio signal to be transmitted to a specific terminal may be generated equally. When a signal generated by a TRP is generated depending on an identifier for each TRP, a representative TRP identifier commonly applied to a plurality of TRPs transmitting the same signal may be shared. Therefore, the respective TRPs may use the representative TRP identifier in a specific situation, that is, when generating a radio signal to be transmitted to a terminal located in an overlapping region of two or more different TRPs. The radio signal generated using the representative TRP identifier may be equally transmitted by TRPs participating in CoMP transmission. A TRP identifier used by the serving TRP to which the terminal is connected among the plurality of TRPs may be configured as the representative TRP identifier and shared among the TRPs.

### 2.6. DU Coverage

As described with reference to the previous drawings, a gNB may be configured by connecting two or more RUs/TRPs to one DU. The DU may exchange data with one TRP or two or more TRPs connected thereto. The DU may perform an operation of providing data to a TRP that transmits a radio signal in a radio section and receiving data from a TRP that receives a radio signal. The radio signal transmission and reception operations of the TRP may be performed according to control information included in data provided to the DU. The DU may control a transmission/reception timing of the TRP when controlling operations of the TRP. In the present disclosure, a DU coverage or a DU radio section coverage may be defined as a region where a TRP connected to a DU transmits a radio signal under a control of the DU.

FIG. 10 is an exemplary diagram for describing a DU coverage and a TRP coverage according to the present disclosure.

FIG. 10 is a configuration diagram for identifying a DU coverage and a TRP coverage in the configuration of FIG. 9 described above. Therefore, the same reference numerals will be used to describe the same configurations as those in FIG. 9.

Referring to FIG. 10, the DU A 901 is connected to three TRPs 911, 912, and 913, and may transmit signals over the entire coverage of a radio section provided by each TRP. Data generated in the DU A 901 may be transmitted as a radio signal through the TRP #1911, TRP A 912, and TRP B 913. In FIG. 10, a DU A coverage 1010 in which a terminal can receive data via the TRP connected to the DU A 901 through a radio signal is illustrated. A terminal located in the DU A coverage 1010 may receive signals from one or more TRPs among the TRPs 911, 912, and 913 connected to the DU A 901. In this case, the DU A 901 may improve a quality of a radio signal transmitted to the terminal by selecting a TRP for transmitting the radio signal according to the location of the terminal. Also, as described above, the DU A 901 may perform control on TRP connection/release according to a reach of the radio signal of the TRP.

As illustrated in FIG. 10, the DUs 901 and 902 connected to the plurality of TRPs 911, 912, 913, 914, and 915 may require a function of performing mutual cooperation, that is, inter-DU cooperation, and using radio resources such as time/frequency/code by dividing them. The DUs 901 and 902 requires a function of exchanging control information with neighboring DUs to divide radio resources so that radio resources allocated to the TRPs connected together (e.g., TRP 913 in FIGS. 9 and 10) do not overlap with each other. If a method of fixedly dividing resources is used for the division of radio resources, the radio resources used in the TRP may be divided by the connected DUs in the fixed manner. Here, an element constituting a radio resource may be a resource, such as time/frequency/code, capable of transmitting data to the terminal which is identifiable in the radio section. For example, a frequency used by the TRP may be fixedly divided for each DU, and each DU may determine a radio resource corresponding to the fixed frequency. The use of radio resources between DUs may be dynamically negotiated and determined in consideration of a buffer status of each DU or a data transmission request of the terminal. By performing a process of negotiating radio resources with neighboring DUs at every unit time, each DU may dynamically utilize the radio resources used at each unit time. As an example of a unit time for which negotiation is performed for dynamic utilization of radio resources, it may be configured identically to a unit of scheduling performed by the DU.

FIG. 10 also illustrates each communication coverage of each of the TRPs 911, 912, 913, and 914. Referring to FIG. 10, a TRP #1 coverage 1011 corresponding to the TRP #1 911, a TRP A coverage 1012 corresponding to the TRP A 912, a TRP B coverage 1013 corresponding to the TRP B 913, and a TRP C coverage 1014 corresponding to the TRP C 914 are illustrated. However, in FIG. 10, a coverage corresponding to the TRP #2 915 is not illustrated due to limitation of the drawing.

### 2.7. DU Switching

As described above for DU switching, an operation of changing a serving DU providing scheduling information such as resource allocation to a terminal is referred to as a DU switching procedure. The terminal may transmit and receive radio signals with a TRP connected to the serving DU and exchange data with the serving DU. As a procedure for changing the serving DU among DUs connected to the TRP, a TRP-independent DU switching procedure is possible.

TRP-independent: DU switching may be performed independently of TRP switching. The TRP switching is a procedure in which the terminal and the base station change a TRP by performing a signaling procedure with the terminal, but the DU switching may be a procedure performed within the base station or a procedure performed by the terminal and the base station. DU switching within the base station is a procedure for switching a DU within the base station without changing a radio interface function performed by the terminal. Therefore, since only DU switching is performed within the same base station, various identifiers and radio parameters of the terminal in the radio interface may not be changed. The DU switching, which is carried out as a procedure involving the terminal, is a procedure in which identifiers and radio parameters shared between the base station and the terminal are changed in the radio interface.

TRP-dependent: DU switching may be performed together with TRP switching. The TRP switching is a procedure in which the terminal and the radio interface are changed, and a TRP-dependent DU switching procedure is a switching procedure involving the terminal. In this switching procedure, identifiers and radio parameters shared by the base station and the terminal may be changed. A procedure for simultaneously changing the DU and the TRP may be similar to a handover procedure generally defined in the 3GPP radio specifications such as LTE/NR.

DU switching region: A region where DU switching can occur in a region where coverages of different DUs overlap is referred to as a DU switching region. In the DU switching region, a serving DU providing a service such as scheduling to a terminal may be changed.

An indication for DU change, that is, a DU switching message may be provided by the serving DU or target DU to the dual access TRP to perform DL switching. The DU switching message may include at least one of serving DU information, target DU information, DU switching time point, resource information, DU switching indication information, or combinations thereof.

Referring to FIG. 10, the TRP B 913 has a dual access TRP structure in which the DU A 901 and the DU B 902 are connected. In FIG. 10, a region where a DU A coverage 1010 and a DU B coverage 1020 overlap may be a DU switching region 1021. The terminal may perform switching between the DU A 901 and the DU B 902 within the same TRP in the DU switching region 1021.

TRP coverage of the same radio resource: If two TRPs transmitting the same data utilize the same radio resource, a TRP with the best radio channel, that is, a region with the best radio channel from the perspective of the terminal may be referred to as a corresponding TRP coverage. In FIG. 10, TRP coverages 1011, 1012, 1013, and 1014 may be regions in which a specific terminal can receive the strongest radio signal in the corresponding region from the corresponding TRP. Such the region will be referred to as a TRP coverage in the present disclosure. When the same data is transmitted through the same radio resource by a plurality of TRPs, the terminal may receive the same data. The base station may receive data based on a procedure for obtaining data from a radio signal received in a radio section. In the structure of FIG. 10, if there is no change in radio resources, even when the terminal moves and the DU is changed, the terminal may receive the same data in the same radio resource.

TRP coverage of different radio resources: Even when different data are transmitted by TRPs in different radio resources, a TRP with the best radio channel for each radio resource may be indicated, and a region with the best radio channel from the perspective of the terminal may be referred to as a TRP coverage.

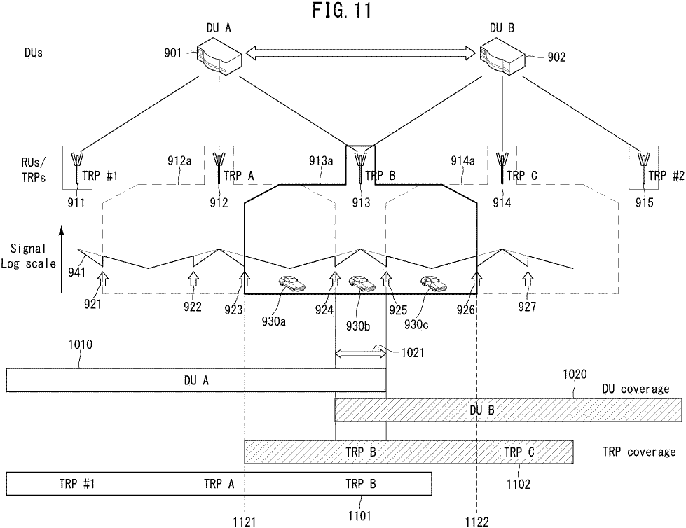

FIG. 11 is an exemplary diagram for describing a DU coverage and a TRP coverage according to the present disclosure.

Referring to FIG. 11, a DU coverage and a TRP coverage will be described. In addition, in FIG. 11, the same reference numerals will be used for the same configurations as those described in FIGS. 9 and 10 described above.

Referring to FIG. 11, the DU A 901 and the DU B 902 transmit different signals. Radio signals generated from the TRPs 911, 912, and 913 connected to the DU A 901 and radio signals generated from the TRPs 913, 914, and 915 connected to the DU B 902 use different radio resources. When the radio resources are separated in this manner, radio signal collision does not occur, and the coverage in which the radio signal transmitted from the TRP B 913 connected to the different DUs 901 and 902 is transmitted may be extended. This will be described in comparison with FIG. 10.

Referring to FIG. 10, it can be seen that a section from a center region in which the CoMP with the TRP A 912 is performed to a center region in which the CoMP with the TRP C 914 is performed becomes the TRB coverage 1013 of the TRP B 913. That is, in FIG. 10, the TRP B coverage 1013 may be a coverage indicated by the reference numerals 1031 to 1032.

On the other hand, referring to FIG. 11, the TRP coverage of the TRP B 913 may be extended to the maximum distance in the direction of a reference numeral 1121, that is, the direction of the TRP A 912. In addition, in the direction of the TRP C 913, it can be extended to the maximum distance, which is the position of a reference numeral 1122.

When the DUs transmit different data, DU switching may include changing the radio resource, and the changed radio resource may be shared to the terminal for each unit time on a radio interface. The terminal using a radio resource scheduled by the DU A 901 may communicate in the TRP coverages of the TRPs 911, 912, and 913 included in the DU A coverage 1010.

When the terminal communicating in the DU A coverage 1010 moves to the DU B coverage 1020, DU switching to the DU B may be performed in the DU switching region 1021 as described above. The terminal whose serving DU has been changed by switching from the DU A 901 to the DU B 902 is included in the TRP coverage 1102 of the TRPs 913, 914, and 915 connected to the DU B 902 within the DU B coverage 1020 of the DU B 902. The terminal 930 may transmit and receive radio signals using a radio resource allocated in the corresponding TRP coverage.

### 2.8. Dual Access TRP Configuration With Multiple TRPs

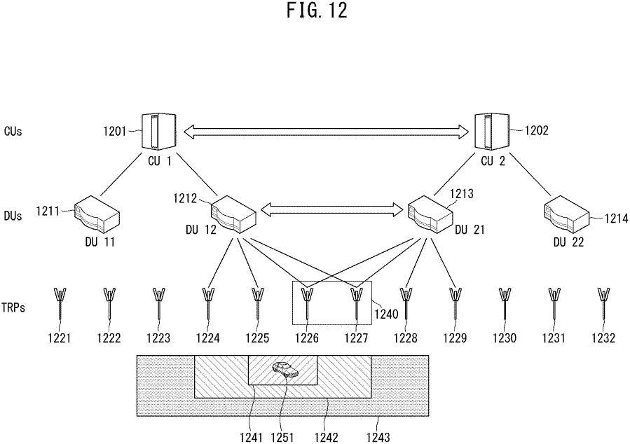

Dual access TRP with Multiple TRPs: An example in which a dual access TRP is configured using multiple TRPs at a boundary of a DU coverage will be described with reference to FIG. 12.

FIG. 12 is an exemplary diagram of a case of configuring a dual access TRP with a plurality of TRPs according to an exemplary embodiment of the present disclosure.

Referring to FIG. 12, two different base station configurations are illustrated. A configuration in which two different DUs 1211 and 1212 are connected under a CU 1 1201, and a configuration in which two different DUs 1213 and 1214 are connected under a CU 2 1202 are illustrated. As described above, inter-gNB cooperation may be performed between the CUs 1201 and 1202.

Only a TRP connection configuration of the DU 12 1212 connected to the CU 1 1201 among the DUs 1211, 1212, 1213, and 1214 is illustrated. The DU 12 1212 may be connected to four TRPs 1224, 1225, 1226, and 1227 among TRPs 1221, 1222, 1223, 1224, 1225, 1226, 1227, 1228, 1229, 1230, 1231, and 1232. In addition, only a TRP connection configuration of the DU 21 1213 connected to the CU 2 1202 among the DUs 1211, 1212, 1213, and 1214 is illustrated. The DU 21 1213 may be connected to four TRPs 1225, 1226, 1227, 1228, and 1229 among TRPs 1221, 1222, 1223, 1224, 1225, 1226, 1227, 1228, 1229, 1230, 1231, and 1232. Connections between other TRPs and DUs are omitted in FIG. 12.

In addition, a case in which the terminal 1251 receives a service while moving between two different TRPs will be described below.

In the drawings described above, only a structure in which one TRP configures a dual access TRP has been described. As shown in FIG. 12, when a dual access TRP is configured using two or more different TRPs, the DU switching region may be expanded compared to the case where dual access TRP is configured using one TRP.

When a radio signal uses a high frequency such as a terahertz (THz) band, a TRP reference radio signal reach coverage is reduced. In this case, when it is necessary to configure a large DU switching region for a fast moving terminal, the DU switching region may be expanded by configuring a plurality of dual access TRPs.

In FIG. 12, for the terminal 1251, TRP switching between the TRP 1225 and the TRP 1226 connected to the DU 12 1212 may be performed. In this case, when the terminal 1251 moves from the TRP 1225 to the TRP 1226 of the DU 12 1212, the DU 12 1212 may perform scheduling so that communication of the terminal 1251 can be seamlessly performed through the TRP switching. Accordingly, the terminal 1251 may be in a state of being connected to the TRP 1225 and/or the TRP 1226 as indicated by a reference numeral 1241.

In addition, neighboring TRPs 1224 and 1227 are indicated as an associated coverage 1242. In the present disclosure, it is assumed that the terminal moves at a high speed and the coverage is narrow because a transmission/reception frequency of the TRP is a very high band. Therefore, in addition to the connected TRPs, at least one neighboring TRP may be additionally considered as the associated coverage 1242 for TRP switching.

Also, as in the typical handover, candidates for TRP switching are exemplified as a candidate coverage 1243 wider than the associated coverage 1242. In FIG. 12, a coverage covered by TRP candidates 1223, 1224, 1225, 1226, 1227 , and 1228 for TRP switching may be the candidate coverage 1243. According to the example of FIG. 12, when switching is performed between the DUs 1212 and 1213, the TRPs 1226 and 1227 commonly connected to the DUs 1212 and 1213 may perform a DU switching procedure.

### Extended DU Switching Region

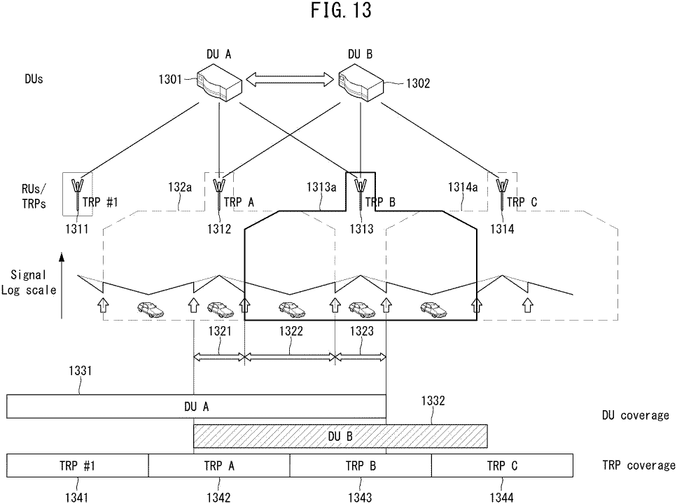

FIG. 13 is an exemplary diagram for describing a DU switching region in the case of having two different dual access TRPs according to an exemplary embodiment of the present disclosure.

Referring to FIG. 13, a DU A 1301 is connected to three different TRPs 1311, 1312, and 1313, and a DU B 1302 is also connected to three different TRPs 1312, 1313, and 1314. FIG. 13 illustrates a case in which a TRP A 1312 and a TRP B 1313 are dual access TRPs connected to the DU A 1301 and the DU B 1302. In addition, FIG. 13 illustrates communication coverages 1312a, 1313a, and 1314a of the TRPs 1312, 1313, and 1314 other than the TRP #1 1311. However, in FIG. 13, a communication coverage of the TRP #1 1311 is not illustrated due to limitations of the drawing. In addition, since a log scale signal graph in FIG. 13 is the same as that described in the previous drawings, additional description thereof will be omitted.

According to the example of FIG. 13, the DU A 1301 and the DU B 1302 may control two TRPs 1312 and 1313 in common. Therefore, TRP switching may be performed differently according to FIG. 13 from the case where the DUs 1301 and 1302 are connected to one dual acess TRP.

According to FIG. 13, the DU switching region may be described by being divided into single TRP portions 1321 and 1323 and a dual TRP portion 1322. In the single TRP portions 1321 and 1323, the terminal is connected to one TRP, and a DU switching procedure may be performed within the same TRP. In the dual TRP portion 1322, a DU switching procedure may be performed in a state in which the terminal is connected to two TRPs 1312 and 1313 for a function such as CoMP. In the dual TRP portion 1322, DU switching and TRP switching may be performed separately or together. In a procedure in which DU switching and TRP switching are performed separately, the DU switching and TRP switching may be performed as independent procedures. In this case, DU switching may proceed without intervention of the terminal if the identifier of the radio interface and the radio parameters do not change.

In FIG. 13, when the same data is transmitted from TRPs connected to one DU to the terminal using the same resource, the DU coverages 1331 and 1332 are separately exemplified.

Referring to FIG. 13, since the TRPs constituting the DU A coverage 1331 and the DU B coverage 1332 transmit the same data using the same resource, as described in FIG. 10, the TRP coverages 1341, 1342, 1343 and 1344 may be configured to cover a region where CoMP communication is performed rather than the entire signal transmission distance.

### Example of Different Radio Resources

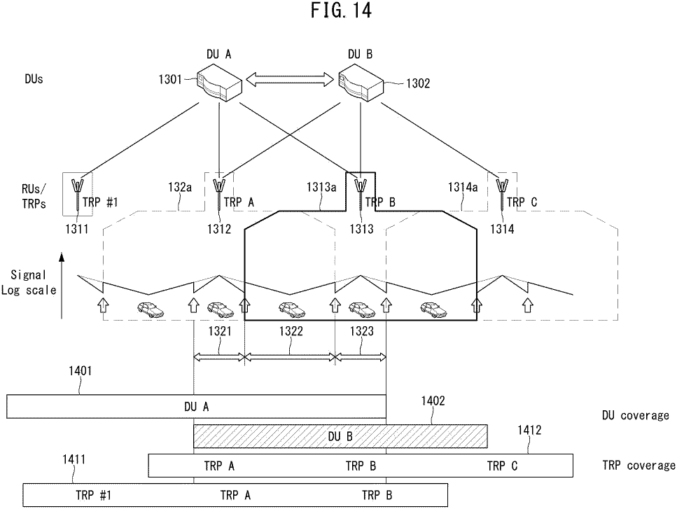

FIG. 14 is an exemplary diagram for describing a DU switching region in the case of having two different dual access TRPs according to another exemplary embodiment of the present disclosure.

The same configurations in FIG. 14 as those in FIG. 13 will be described using the same reference numerals. FIGS. 13 and 14 show a difference only in an example of utilizing resources, and since the configurations are the same, description on the same configurations will be omitted.

At a boundary between the DUs 1301 and 1302, two dual access TRPs 1312 and 1313 are configured to configure signals in different radio resources between the two TRPs 1312 and 1313. In the structure in which the DU A 1301 and the DU B 1302 transmit different data in different radio resources, a DU A coverage 1401 of DU A 1301 and a DU B coverage 1402 of DU B 1302 are illustrated separately. In addition, a TRP coverage 1411 of the TRPs 1311, 1312, and 1313 connected to the DU A 1301 and a TRP coverage 1412 of the TRPs 1312, 1313, and 1314 connected to the DU B 1302 are illustrated. Since the coverages of the TRPs illustrated in FIG. 14 use different radio resources as described above with reference to FIG. 11, they may be determined corresponding to coverages 1312a, 1313a, and 1314a corresponding to the signal transmission distances of the respective TRPs.

### 2.9. Resource Nulling

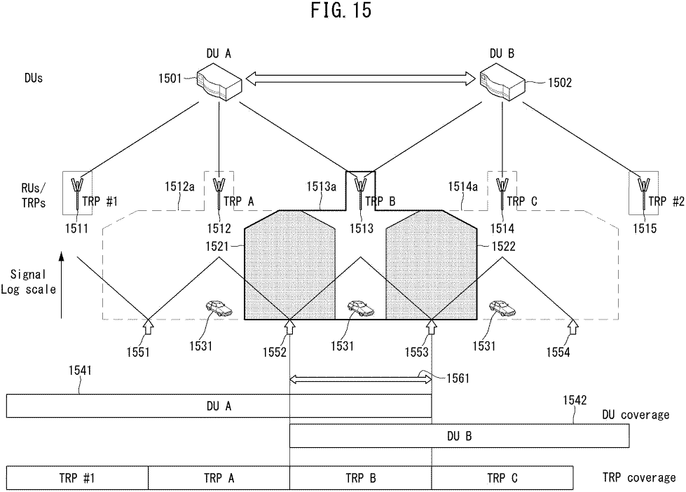

FIG. 15 is an exemplary diagram for describing an operation according to resource nulling according to an exemplary embodiment of the present disclosure.

Referring to FIG. 15, a configuration in which three different TRPs 1511, 1512, and 1513 are connected under a DU A 1501 is illustrated. In addition, a configuration in which three different TRPs 1513, 1514, and 1515 are connected under a DU B 1502 is illustrated.

The configuration of FIG. 15 is not different from those of FIGS. 9 to 11, 13 and 14. However, although the CoMP-based operations have been described in FIGS. 15, 9, 11, 13, and 14, FIG. 15 is different in that it is an example for describing an operation for resource nulling. In addition, as can be seen from CU coverages 1541 and 1542 in FIG. 15, it can be seen from the foregoing description that the same radio resources are used between the DU A 1501 and the DU B 1502.

In addition, signal transmission distances 1512a, 1513a, and 1514a of the respective TRPs 1512, 1513, and 1514 are exemplified, and signal transmission distances of a TRB #1 1511 and a TRP #2 1515 are not shown due to limitation of the drawing.

FIG. 15 also shows a log scale strength of a signal received from the terminal 1531. That is, it can be seen that the signal strength according to a loss scale linearly decreases as the distance from the TRP increases, and the signal strength on a log scale increases linearly as the TRP approaches.

Resource nulling: As described above, resource nulling for utilizing radio resources in a scheme in which only a serving TRP utilizes radio resources allocated to a terminal 1531 in a region (i.e., TRP boundary region) where radio signals of TRPs are received overlappingly. In this case, radio resource allocation may be performed so that a neighboring TRP other than the serving TRP does not use the radio resources allocated to the terminal in the TRP boundary region.

Inter-TRP switching: A scheme of switching a serving TRP at a TRP boundary region is referred to as inter-TRP switching. This may be understood the same as the TRP switching described above. In the present disclosure, the TRP switching and the inter-TRP switching may be understood as the same or similar form.

A location where inter-TRP switching occurs may be predetermined regions 1521 and 1522 including a location where signals of the same strength arrive at the terminal 1531 from the serving TRP and the target TRP. In the example of FIG. 15, inter-TRP switching may be performed at a location indicated by a reference numeral 1552 where signals received from the TRP A 1512 and TRP B 1513 are lowest. That is, in the terminal 1531, which is at a specific location in the region 1521 where the TRP A 1512 and the TRP B 1513 overlap, the TRP switching may be performed at a location where signals of the same strength arrive from the serving TRP and the target TRP. TRP switching may be performed also between the TRP B 1513 and the TRP C 1514 at a specific location of a region 1522 where the two TRPs 1513 and 1514 overlap.

Each of the DUs 1501 and 1502 performing scheduling to the terminal may perform inter-TRP switching at a location where signals from the TRPs have the same strength in order to allow the terminal to perform the inter-TRP switching while maintaining high (the maximum) quality signals from the respective TRPs. Of course, at this time, a phenomenon in which the quality of radio signals is rapidly deteriorated by a signal from a neighboring TRP may be prevented from occurring by using resource nulling in which the neighboring TRP does not use the radio resources. FIG. 15 illustrates locations 1551, 1552, 1553, and 1554 where inter-TRP switching occurs in the TRP boundary region.

### Dual Access TRP

Referring to FIG. 15, the dual access TRP 1513 connected to a plurality of DUs 1501 and 1502 and processing radio signals may be configured at a DU boundary. FIG. 15 illustrates a case in which the TRP B 1513 is configured as a dual access TRP at the boundary between the DU A 1501 and DU B 1502. A region where the DU A coverage 1541 and the DU B coverage 1542 overlap may correspond to the TRP B 1513 coverage. In this case, the DU A 1501 and the DU A 1502 may use the same resource as described above. Therefore, when the terminal 1531 configuring the TRP B 1513 as a serving TRP moves in a specific direction, for example, when the terminal moves from a location adjacent to the TRP A 1512 to a location adjacent to the TRP C 1514 within the coverage of the TRP B 1513, a procedure for changing the serving DU from the serving DU A 1501 to the target DU B 1502 may be performed. Alternatively, a procedure for changing the serving DU in the opposite direction may be performed according to the initial location and moving direction of the terminal. In this case, a DU switching region 1561 may be configured similarly to the dual access TRP coverage.

TRP coverages of the same resource: FIG. 15 illustrates the TRP coverages 1541 and 1542 in a scheme in which the DU A 1501 and the DU B 1502 manage signals in the same radio resource. Since all TRPs use the same radio resource in the TRP coverages, a TRP boundary may be determined based on signal strengths.

### TRP Coverages of Different Resources

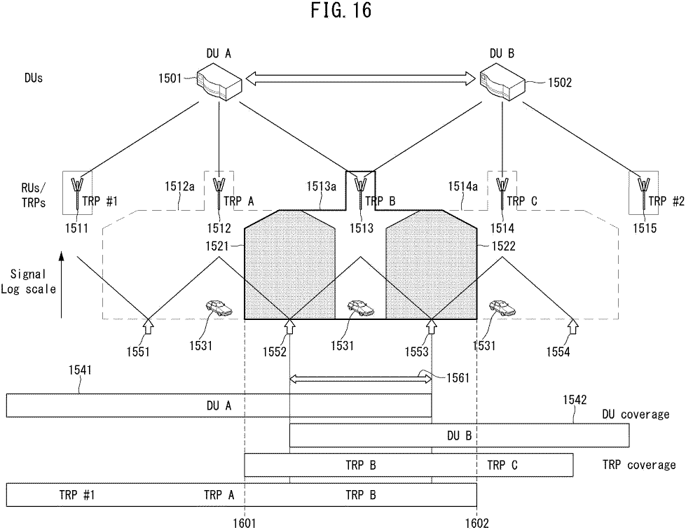

FIG. 16 is an exemplary diagram for describing an operation according to resource nulling according to another exemplary embodiment of the present disclosure.

FIG. 16 shows the same network configurations as those of FIG. 15. Therefore, redundant description on network configurations will be omitted. In addition, in the present disclosure, the method for reducing interference from another TRP in a neighboring region between TRPs through resource nulling may be equally applied.

However, in FIG. 16, unlike the description of FIG. 15, the DU A 1501 and the DU B 1502 may transmit signals to the terminal 1531 using different radio resources. That is, resources allocated (i.e., managed for) to the terminal 1531 by the DU A 1501 and the DU B 1502 may be different. When the DU A 1501 and the DU B 1502 use different resources in this manner, the TRP coverages may become different as described above.

When the radio resource used by the DU A 1501 and the radio resource used by the DU B 1502 are different, the TRP B 1513 connected to the DU A 1501 and the DU B 1502 is scheduled by the DU A 150 and communicates with the terminal, the coverage of the TRP B 1513 based on the DU A 1501 is extended to a range where the signal of the TRP reaches, that is, the actual entire range of the TRP, as shown by a reference numeral 1602.

In addition, the TRP B 1513 operates as being connected with the DU B 1502. When it is scheduled by the DU B 1502 and communicates with the terminal, the coverage of the TRP B 1513 based on the DU B 1502 is extended to a range where the signal of the TRP reaches, that is, the actual entire range of the TRP, as shown by a reference numeral 1601.

As described above, a delay of services provided to the terminal may be reduced by using the dual access TRP structure according to the present disclosure and providing TRP switching in the resource nulling or CoMP scheme based on inter-DU cooperation. In particular, in the case of XR services requiring high-speed data with low latency and/or when the terminal moves at a high speed, the methods according to the present disclosure can provide higher quality services to the user.

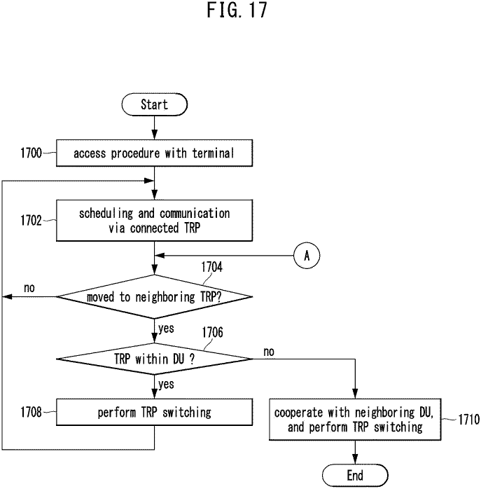

FIG. 17 is a control flowchart for TRP switching when providing services to a terminal according to an exemplary embodiment of the present disclosure.

Prior to referring to FIG. 17, it is assumed that the control operation of FIG. 17 may be an operation performed by a DU, and that the DU is connected to one or more TRPs. In addition, the DU may be connected with at least one dual access TRP. That is, the DU may be a DU based on the contents of FIGS. 3–5 6A 6B 6C 6D 6E 6F 7A 7B 7C 8–16 above.

Referring to FIG. 17, in step 1700, the DU may perform an access procedure with a terminal. During the access procedure with the terminal, the DU may perform the access procedure with the terminal through at least one TRP among TRPs connected under the DU. The access procedure with the terminal may include a procedure in which the terminal initiates communication by transmitting a PRACH preamble on a random access channel (RACH). Before the terminal transmits the PRACH preamble and initiates communication, the DU may be in a state in which TRP identifiers (or per-TRP identifiers) are allocated for identifying the respective TRPs. Accordingly, when a plurality of TRPs are connected to the DU, each TRP may periodically broadcast its own TRP identifier to the terminal. Therefore, the terminal may recognize which TRP it is connected to through the TRP identifier.

As another example of the present disclosure, the TRP may use the TRP identifier only between the DU and the TRP. When the TRP identifier is used only between the DU and the TRP, the TRP identifier may not be broadcast to the terminal. If a preamble is transmitted by a specific terminal through a PRACH, the TRP may transmit a preamble signal including the TRP identifier for notifying the TRP to the DU.

In step 1700 of FIG. 17, the access procedure with the terminal has been described assuming that the terminal performs the RACH procedure. However, the reverse direction is also included. For example, when the terminal is in RRC standby state (e.g., RRC idle state or RRC inactive state) and receives data to be transmitted to the terminal from an upper network, the DU may transmit a paging signal to the corresponding terminal through TRPs connected to it. The terminal may initiate communication in response to the paging signal. Step 1700 may include both downlink communication initiation and uplink communication initiation.

In step 1702, the DU may perform scheduling through a TRP to which the terminal is connected and communicate based on the scheduling. That is, the DU may transmit and receive data through the TRP connected to the terminal. The processing of the DU in step 1702 may be operations of the RLC layer, the MAC layer, and the PHY-High sublayer in FIG. 5 described above.

In addition, when the TRP connected to the DU is connected to only one DU, the TRP may be composed of only PHY-Low sublayer(s). In this case, it may take a basic form in terms of Cloud-RAN functional split.

As another example, when the TRP connected to the DU is connected to two or more DUs, the TRP may be composed of PHY-Low-S sublayer(s) and a PHY-Low-Comm sublayer.

In step 1702, if the TRP connected to communicate with the terminal is a dual access TRP connected to two or more DUs, the DU may transmit data to be transmitted to the terminal through the PHY-Low-S sublayer connected to the DU within the TRP. A procedure for the TRP connected to different DUs will be further described in FIG. 18 to be described later.

In step 1704, the DU may identify whether the terminal moves to a neighboring TRP. Identification of whether the terminal moves to a neighboring TRP may be based on information received from the terminal. For example, the terminal may periodically or aperiodically report information on a signal strength of a communicating TRP and information on a signal strength received from a neighboring TRP. The signal strength information reported by the terminal may be provided to a currently connected DU, that is, the DU connected to the serving TRP through the serving TRP.

The DU may identify whether the terminal moves to another TRP (or should move to another TRP) based on the signal strength information from the terminal received through the TRP. When the terminal needs to move to another TRP based on the signal strengths, the DU proceeds to step 1706, and when the terminal does not need to move to another TRP, scheduling and communication may be performed through the TRP connected in step 1702.

As a result of the identification in step 1704, when the terminal moves to a neighboring TRP, the DU may identify whether the terminal moves to another TRP within the DU in step 1706. As described above, such identification may be performed using the TRP identifiers and the signal strength information about the TRPs reported by the terminal. The DU is in a state of knowing the identifiers of the TRPs connected to the DU. Also, the DU may know in advance the identifiers of TRPs connected to the neighboring DU. The identifier of another neighboring TRP may be provided from the neighboring DU or stored in advance by a system manager.

As a result of the identification in step 1706, when the terminal communicating with a specific TRP moves from the serving TRP to another TRP within the DU, the DU may proceed to step 1708, and when the terminal moves to a TRP connected to another neighboring DU, the DU may proceed to step 1710.

The case of proceeding from step 1706 to step 1708 will be described with reference to FIGS. 6A, 6D, and 6F described above.

Referring to FIG. 6A, the TRP 621 and TRP 622 are connected under the DU 611, and the TRP 622 and TRP 623 are connected under the DU 612. When the terminal 631 connected to the DU 611 moves to the neighboring TRP 622 while performing steps 1700 to 1702 with the TRP 621, the DU 611 may proceed from step 1706 to step 1708. Similarly, the TRP 622 and TRP 623 are connected under the DU 612, and the TRP 622 and TRP 623 are connected under the DU 612. When the terminal 631 connected to the DU 612 moves to the neighboring TRP 623 while performing steps 1700 to 1702 with the TRP 622, the DU 612 may proceed from step 1706 to step 1708.

When the terminal move within the same DU in this manner, the DU may perform TRP switching in step 1708. The TRP switching may be an operation of changing the TRP as described above. The TRP switching in step 1708 according to the present disclosure may minimize signal interruption time from the perspective of the terminal because switching between TRPs connected within one DU is performed. During the TRP switching, the DU may provide seamless services using the same radio resource in the target TRP.

According to an exemplary embodiment of the present disclosure, when performing the TRP switching in step 1708, interference from the neighboring TRP may be removed using the resource nulling scheme. For example, when the terminal 631 of FIG. 6A moves to the neighboring TRP 622 while communicating with the TRP 621, the target TRP 622 may be scheduled during a period in which the terminal communicates with the TRP 621, so that data is not transmitted to another terminal through the same radio resource. In addition, when a communication channel is handed over (passed over) to the TRP 622, which is the target TRP, from the previous serving TRP 621 of the terminal 631, the previous serving TRP 621 may be scheduled so that data is not transmitted to another terminal through the same radio resource for a certain time or until the terminal 631 enters a certain region of the TRP 622.

According to another exemplary embodiment of the present disclosure, when the TRP switching is performed in step 1708, the same data may be transmitted through the same resource by the serving TRP and the target TRP in the CoMP scheme, thereby removing interference and simultaneously improving the received signal quality in the terminal. For example, when the terminal 631 of FIG. 6A moves to the neighboring TRP 622 while communicating with the TRP 621, the target TRP 622 may be scheduled to transmit the same data the terminal 631 communicating with the TRP 621 through the same radio resource during a period in which the terminal communicates with the TRP 621. The period in which the same data is transmitted through the same radio resource from two different TRPs to one terminal 631 may follow a form defined in CoMP scheme-based communication.

On the other hand, as a result of the identification in step 1706, when the terminal does not move to a TRP within the same DU, the DU may proceed to step 1710.

In step 1710, the DU may cooperate with a neighboring DU and perform TRP switching based on the cooperation. The TRP switching in step 1710 may be performed in the following cases.

First, TRP switching between different DUs included in the same base station may be performed.

Second, TRP switching between DUs of different base stations may be performed.

First, TRP switching between different DUs included in the same base station will be described. The TRP switching between different DUs within the same base station may be applied when there is no dual access TRP according to the present disclosure. This will be described with reference to FIG. 6A.

It can be assumed that the DU 613 and the DU 614 illustrated in FIG. 6A are included within one base station. It should be noted that this is an assumption different from that of the method described above with reference to FIGS. 6A and 6B.

Under the above assumption, the terminal 631 communicating through the TRP 625 connected to the DU 614 may move in the direction of the TRP 624. When the different TRPs 624 and 625 located within one base station are connected to the different DUs 613 and 614, cooperation between the DUs 613 and 614 may be performed.

The cooperation may be cooperation for performing resource nulling or CoMP-type communication for the TRP switching based on the movement of the terminal. When resource nulling is performed, interference may be reduced from the perspective of the terminal by not allocating the same radio resource to another terminal in the target DU while communication is being performed by being connected to the serving DU. When CoMP-type communication is performed, the serving DU and the target DU may transmit the same data to the terminal performing the TRP switching using the same radio resource. The different TRPs 624 and 6225 may transmit and receive the same data to and from the terminal 631 for which the TRP switching is performed using the same radio resource. In this case, as described in FIGS. 6A to 6F, the terminal has an advantage of being able to receive signals with a signal strength 3 dB higher in the TRP switching region.

Next, the case in which a neighboring TRP is included in a DU of another base station will be described. It is assumed that TRP switching according to the present disclosure is performed between the TRP 623 and the TRP 624 described in FIG. 6A. The TRP 623 is connected under the DU 612, and the TRP 624 is connected under the DU 613. In addition, the base station including the DU 612 and the TRP 612 and the base station including the DU 613 and the TRP 624 may be different base stations. It should be noted that some of these assumptions may be different from the assumptions in FIGS. 6A and 6C described above.

Under the above assumption, the terminal 631 communicating through the TRP 623 connected to the DU 612 may move in the direction of the TRP 625. When moving between the different TRPs 624 and 625 included in different base stations, cooperation between the DUs 612 and 613 may be performed.

Since the DU 612 and DU 613 are included in different base stations, the cooperation between the current DUs may be performed using a X2 interface, which is an upper interface of the DUs 612 and 613. Therefore, in the case of switching between TRPs included in different base stations, the cooperation should be performed through a CU as well as the DUs. Accordingly, as described in FIG. 8, a time required for the cooperation may increase. However, even if the TRP switching is performed through the cooperation between the DUs included in different base stations, as described above, interference between the TRPs may be reduced by using resource nulling or CoMP schemes, or signals may be received at a 3 dB higher signal strength from the perspective of the terminal.

According to the methods described above, reception performance can be improved in the terminal through TRP switching according to the present disclosure even when there is no dual access TRP.

FIG. 18 is a control flowchart for DU switching when providing services to a terminal according to an exemplary embodiment of the present disclosure.

Prior to referring to FIG. 18, a control operation of FIG. 18 may be an operation performed by a DU, and a case in which the DU is connected to at least one dual access TRP will be described. When the DU is connected to the dual access TRP, the DU may be a DU based on the contents of FIGS. 3–5 6A 6B 6C 6D 6E 6F 7A 7B 7C 8–16 above.

Referring to FIG. 18, in step 1800, the DU may perform an access procedure with a terminal. In this case, it may be assumed that the DU performs the access procedure with the terminal through the dual access TRP. Compared to step 1700 of FIG. 17, step 1800 has no other difference except that the access procedure is performed with the terminal through the dual access TRP. In addition, as described in step 1700 of FIG. 17, step 1800 may include an operation of accessing the terminal through a paging procedure when there is data to be transmitted from an upper network to the corresponding terminal.

In step 1802, the DU may perform scheduling through the dual access TRP to which the terminal is connected and communicate based on the scheduling. That is, the DU may transmit and receive data through the dual access TRP connected to the terminal.

In addition, the operation of step 1802 may be applied to a case where the TRP is switched from another TRP to the dual access TRP through the procedure of FIG. 17 and communication is performed with the terminal. The TRP switching procedure from another TRP to the dual access TRP may be applied to a case in which the target TRP is the dual access TRP in the procedure of FIG. 17. Accordingly, in step 1802, when the terminal moves from the previous serving TRP to the dual access TRP and the TRP is switched to the dual access TRP, scheduling and communication may be performed through the connected TRP, that is, the dual access TRP.

The scheduling and communication will be described using the dual access TRP configuration of FIG. 5.

The dual access TRP will be described again with reference to the example in FIG. 5. As illustrated in FIG. 5, the dual access TRP 531 may be connected to two different DUs 511 and 521. The DU 511 may have a configuration for performing operations of the RLC layer, MAC layer, and PHY-High sublayers. Another DU 521 may also have a configuration for performing operations of the RLC layer, MAC layer, and PHY-High sublayers.

The dual access TRP 531 may receive information on scheduled resources and data for communication through a PHY-Low-S sublayer connected only to the DU 511. In addition, the dual access TRP 531 may receive information on scheduled resources and data for communication through a PHY-Low-S sublayer connected only to the DU 521.

The PHY-Low-S sublayer connected only to the DU 511 of the dual access TRP 531 and the PHY-Low-S sublayer connected only to the DU 521 of the dual access TRP 531may communicate with the terminal through a PHY-Low-Comm sublayer, respectively. Therefore, when a specific terminal communicates in the dual access TRP 531, in order to allocate radio resources between the DUs 511 and 512 in a state where radio resources are not fixed, inter-DU cooperation may be continuously required while the terminal communicates in the dual access TRP.

In step 1804, the DU may identify whether DU switching is required to continue services to the terminal communicating with the dual access TRP.

There may be various methods for the dual access TRP to identify whether DU switching is required. Looking at some of the various methods as examples, it is possible to identify whether or not DU switching from one DU to a neighboring DU is required based on a movement path of the terminal for a certain period of time. If the terminal continuously moves in one direction as illustrated in FIG. 6A on a one-way automobile-only road, the DU may determine DU switching based on a movement history of the terminal. In this case, as the movement history of the terminal, TRP switching history information of the TRPs connected to the DU may be used. Additionally, when cooperation with a neighboring DU is possible, TRP switching history information from the neighboring DU may be further used. Additionally, when TRP switching history information can be obtained from a neighboring base station, movement history information of the terminal received from the neighboring base station may be further used.

As another example, as described in FIGS. 10, 11, 13, 14, 15, and 16 of the present disclosure, a region in which the signal strength of the dual access TRP is high may be regarded as a DU switching region. Accordingly, DU switching may be determined when the terminal moves from the center of the TRP (a region where the signal strength from the dual access TRP is high) to a direction of another specific neighboring TRP. These DU switching regions may be defined as a region which is both an overlapping region of the DUs and a region around the central region of the dual access TRP. A criterion for the center region may be determined based on the signal strength received from the TRP.

As described above, the terminal may report the strength of the signal received from the connected TRP and the signal strength from the neighboring TRP to the DU at a predetermined period or aperiodically under the control of the DU. The DU may identify whether the terminal is located within a preconfigured overlapping DU region based on the received signal strength information. Also, movement in a specific direction may be identified using the signal strength information of neighboring TRPs. Based on this, the DU may identify whether DU switching is required in step 1804.

The movement history of the terminal, the movement direction of the terminal, or the strength of the signal received from the terminal may be determined in advance and may be one condition for DU switching. As the DU switching condition, various other information may be used. For example, a DU switching condition may be configured based on a load state in the serving DU. As such, the DU switching condition may be configured variously.

If it is determined that DU switching is required using one of the above methods or other methods, cooperation with a neighboring DU and DU switching may be performed in step 1806.

The DU switching may be performed by providing a DU switching message to the dual access TRP by the serving DU or target DU. The DU switching message may include at least one of serving DU information, target DU information, DU switching time, resource information, DU switching indication information, or combinations thereof.

The DU switching has been described in Section 2.7 of the present disclosure, and since it has been described in FIGS. 10, 12, and 13 to 16, redundant description will be omitted. When the DU switching is performed, the routine of FIG. 18 may end because the DU no longer provides services to the corresponding terminal.

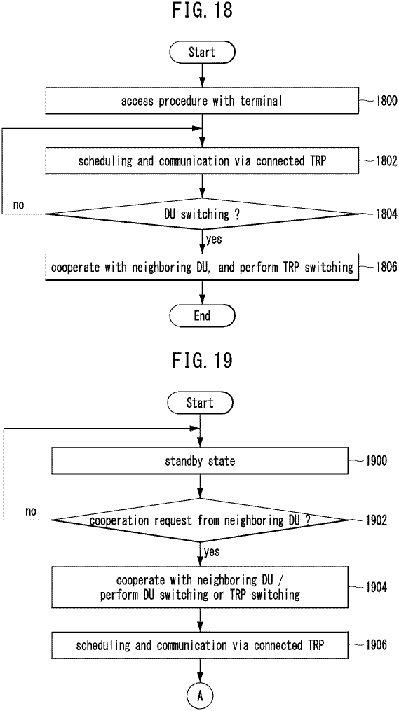

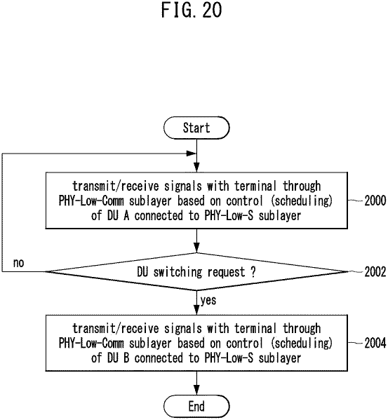

FIG. 19 is a control flowchart when a call transfer is requested from a neighboring DU according to an exemplary embodiment of the present disclosure.

Prior to referring to FIG. 19, it is assumed that a control operation of FIG. 19 may be performed by a DU, and that the DU is connected to one or more TRPs. Also, the DU may be connected with at least one dual access TRP. The DU may be a DU based on the contents of FIGS. 3–5 6A 6B 6C 6D 6E 6F 7A 7B 7C 8–16 above.

In addition, FIG. 19 shows a control flow in the target DU when a terminal receives a transferred call, that is, when a seamless service is provided to the terminal serviced by another DU through DU switching and/or TRP switching.

The DU may maintain a standby state at step 1900. This may indicate a standby state for a call transfer request. Accordingly, the standby state may include a state in which scheduling for the corresponding terminal and transmission/reception of data with the corresponding terminal are performed when another terminal is communicating within the corresponding DU.

In step 1902, the DU may check whether a cooperation request is received from a neighboring DU. The cooperation request from a neighboring DU may use an interface defined between the DUs when the interface is defined between the DUs. When the interface is not defined between the DUs, cooperation may be requested through a CU connected above the DUs. As another example, when a path or interface for cooperation is defined through the dual access TRP to which the DUs are connected according to the present disclosure, the cooperation may be requested through the dual access TRP.

As a result of the checking in step 1902, if a cooperation request is received from a neighboring DU, the DU may proceed to step 1904, and if a cooperation request is not received, the DU may proceed to step 1900.

In step 1904, the DU may perform DU switching or TRP switching through cooperation with the neighboring DU. In the case of DU switching, as in the case of FIG. 18 described above, it may be a procedure of changing the DU in the dual access TRP. The DU switching may be performed in a region where DU coverages overlap. Since the specific DU switching procedure has been described in the previous drawings, redundant description will be omitted.

In step 1904, the DU may perform TRP switching based on cooperation when the TRP switching is required. Such the TRP switching may be performed according to the method described in step 1710 of FIG. 17 above. However, a difference from step 1904 is that step 1906 may be performed after step 1904 because the DU takes over the call.

In step 1906, since the DU takes over the call of the terminal according to the DU switching or the TRP switching, scheduling for the terminal may be performed through the TRP to which the terminal is connected and data may be transmitted/received with the terminal based on the scheduling. Thereafter, the DU may be configured to perform step 1704 of FIG. 17. That is, the DU may identify whether the terminal moves to a neighboring TRP, and when the terminal moves to the a neighboring TRP, the DU may proceed to step 1706. When the terminal does not move to a neighboring TRP, scheduling and communication may be performed through the TRP to which the terminal is connected.

The flowcharts of FIGS. 17 to 19 described above have been illustrated and described as separate drawings to describe the respective features according to the present disclosure. However, in actual implementation, all of the methods described above may be implemented in the DU as shown in a form combining the methods of FIGS. 17 and 19. Also, in the descriptions of FIGS. 17 to 19, some functions may be omitted or deleted due to implementation needs.

FIG. 20 is a control flowchart when a dual access TRP communicates with a terminal according to an exemplary embodiment of the present disclosure.

In FIG. 20, it is assumed that a dual access TRP is connected to a DU A and a DU B. In addition, the dual access TRP will be described on the assumption that it has the structure described in FIG. 5 above.

Referring to FIG. 20, in step 2000, the dual access TRP may transmit or receive signals (or data) with a terminal through a PHY-Low-Comm sublayer based on control (scheduling) of the DU A connected to a PHY-Low-S sublayer.

In the dual access TRP, DU switching may be performed as described in FIGS. 6A and 6E. Accordingly, the dual access TRP may identify whether DU switching is requested in step 2002. The DU switching request may be made by the serving DU providing at least one of serving DU information, target DU information, DU switching time, resource information, DU switching indication information, or combinations thereof corresponding to the dual access TRP based on cooperation with a target DU.

As a result of the identification in step 2002, if DU switching is requested, the dual access TRP may proceed to step 2004.

The dual access TRP may perform DU switching according to the DU switching request in step 2004. The DU switching may be performed based on the DU switching indication information. In addition, the DU may switch the PHY-Low-S sublayer based on the serving DU information and the target DU information, and may perform the DU switching according to the DU switching time. In addition, based on the resource information, communication with the terminal may be performed using resources allocated in the PHY-Low-Comm sublayer. In this case, as described above, since the DU switching is performed based on inter-DU cooperation and is performed within one TRP, seamless services may be provided to the terminal. In particular, in the case of using the methods according to the present disclosure, high-capacity data may be transmitted at a high speed, for services such as XR services, and reliable services without interruption may be provided.

In addition, the methods described above have been described assuming a specific system to help understanding of the present disclosure, but they may be applied to various implementation forms of the communication system using DUs and RU/TRPs other than the specific system described in the present disclosure.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to steps of the method or the features of steps. Similarly, the aspects described in the context of the method may be expressed as the features of the corresponding blocks or items or the corresponding apparatus. Some or all of steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. An operation method of a transmission and reception point (TRP) constituting a base station, the operation method comprising:
receiving, from a first distributed unit (DU) and through a first physical layer, scheduling information of a first terminal and first data to be transmitted to the first terminal;
receiving, from a second DU and through the first physical layer, scheduling information of a second terminal to be provided to the second terminal and second data to be transmitted to the second terminal; and
simultaneously transmitting the first data and the second data to the first terminal and the second terminal, respectively, through a second physical layer based on the scheduling information of the first terminal and the scheduling information of the second terminal.

2. The operation method according to claim 1, wherein the first physical layer includes a first physical lower-split (PHY-Low-S) sublayer subordinately connected to the first DU and a second physical lower-split (PHY-Low-S) sublayer subordinately connected to the second DU.

3. The operation method according to claim 2, wherein the second physical layer includes a physical lower-common (PHY-Low-Comm) sublayer for communicating with the first terminal and the second terminal.

4. The operation method according to claim 3, further comprising transmitting uplink data to the first DU through the first PHY-Low-S sublayer when uplink data is received from the first terminal through the PHY-Low-Comm sublayer.

5. The operation method according to claim 3, further comprising switching a connection for the first terminal from the first PHY-Low-S sublayer to the second PHY-Low-S sublayer when a DU switching message requesting switching to the second DU for the first terminal is received from the first DU.

6. The operation method according to claim 5, wherein the DU switching message includes at least one of information on a serving DU, information on a target DU, information on a DU switching time, resource information, DU switching indication information, or combinations thereof.

7. The operation method according to claim 5, further comprising transmitting uplink data to the second DU through the second PHY-Low-S sublayer when the uplink data is received from the first terminal through the PHY-Low-Comm sublayer.

8. The operation method according to claim 3, wherein the PHY-Low-Comm sublayer provides a radio interface for transmitting and receiving data with the first terminal and the second terminal.

9. A transmission and reception point (TRP) apparatus constituting a base station, the TRP apparatus comprising:
a first physical layer configured to receive, from a first distributed unit (DU), scheduling information of a first terminal and first data to be transmitted to the first terminal, and receive, from a second DU, scheduling information of a second terminal to be provided to the second terminal and second data to be transmitted to the second terminal;
a second physical layer configured to simultaneously transmit the first data and the second data to the first terminal and the second terminal, respectively, through a second physical layer based on the scheduling information of the first terminal and the scheduling information of the second terminal; and
a processor configured to control a connection between the first physical layer and the second physical layer.

10. The TRP apparatus according to claim 9, wherein the first physical layer includes a first physical lower-split (PHY-Low-S) sublayer subordinately connected to the first DU and a second physical lower-split (PHY-Low-S) sublayer subordinately connected to the second DU.

11. The TRP apparatus according to claim 10, wherein the second physical layer includes a physical lower-common (PHY-Low-Comm) sublayer for communicating with the first terminal and the second terminal.

12. The TRP apparatus according to claim 11, wherein when uplink data is received from the first terminal through the PHY-Low-Comm sublayer, the processor further controls the uplink data to be transmitted to the first DU through the first PHY-Low-S sublayer.

13. The TRP apparatus according to claim 11, wherein when a DU switching message requesting switching to the second DU for the first terminal is received from the first DU, the processor further controls a connection for the first terminal to be switched from the first PHY-Low-S sublayer to the second PHY-Low-S sublayer.

14. The TRP apparatus according to claim 13, wherein the DU switching message includes at least one of information on a serving DU, information on a target DU, information on a DU switching time, resource information, DU switching indication information, or combinations thereof.

15. The TRP apparatus according to claim 13, wherein when uplink data is received from the first terminal through the PHY-Low-Comm sublayer, the processor further controls the uplink data to be transmitted to the second DU through the second PHY-Low-S sublayer.

16. The TRP apparatus according to claim 11, wherein the PHY-Low-Comm sublayer provides a radio interface for transmitting and receiving data with the first terminal and the second terminal.

17. A method by a first distributed unit (DU), comprising:
communicating with a first terminal through a first transmission and reception point (TRP), wherein the first TRP is connected to the first DU and a second DU;
identifying whether a DU switching condition for DU switching from the first DU to the second DU is satisfied for the first terminal;
cooperating with the second DU for the first terminal when the DU switching condition is satisfied;
transmitting a DU switching message including a result of the cooperation to the first TRP; and
releasing a connection with the first TRP for the first terminal.

18. The method according to claim 17, wherein the DU switching message includes at least one of information on a serving DU, information on a target DU, information on a DU switching time, resource information, DU switching indication information, or combinations thereof.

19. The method according to claim 17, wherein the communicating with the first terminal comprises:
transmitting scheduling information of the first terminal to a first physical lower-split (PHY-Low-S) sublayer subordinate to the first DU through a physical higher (PHY-High) sublayer; and
transmitting first data to be transmitted to the first terminal to the first PHY-Low-S sublayer subordinate to the first DU through the PHY-High sublayer.

20. The method according to claim 17, wherein the cooperating comprises:
providing, to the second DU, at least one of information on a service for the first terminal, a data transmission rate, a resource allocated to the first TRP, a DU switching time, or combinations thereof; and
receiving, from the second DU, a response of accepting or modifying a DU switching.
